(19) United States
(12) Patent Application Publication
(10) Pub. No.: US 2015/0254025 A1
(43) Pub. Date: Sep. 10, 2015

(54) FAX DEVICE, AND PRINTING DEVICE

(71) Applicant: SEIKO EPSON CORPORATION, Tokyo (JP)

(72) Inventors: Ikumi WATANABE, Shiojiri (JP); Hiromichi YAMAGISHI, Shiojiri (JP)

(21) Appl. No.: 14/536,211

(22) Filed: Nov. 7, 2014

(30) Foreign Application Priority Data
Mar. 5, 2014 (JP) 2014-042699
Mar. 5, 2014 (JP) 2014-042700

(51) Int. Cl. G06F 3/12; H04N 1/00

(52) U.S. Cl. CPC G06F 3/1204; G06F 3/1256; G06F 3/1258; H04N 1/00724; H04N 1/00694; H04N 1/00689; H04N 1/00779; H04N 1/00771

(57) ABSTRACT

A printing device includes an input unit, a paper feed unit, a printing unit, and a control unit configured to record a type of paper received via the input unit as a print setting by a user, and, according to a type of paper input from the user, cause the paper feed unit to feed paper and cause the printing unit to perform printing on the paper. The control unit is configured to inquire of the user a type of paper loaded in a first case where the paper is detected to be loaded in the paper feed unit in a normal state, and configured not to perform the same inquiry as with the first case in a second case where the paper is detected to be loaded in the paper feed unit during the print setting using a type of paper different from the type of paper being recorded.

### CROSS-REFERENCE TO RELATED APPLICATIONS

This application claims priority to Japanese Patent Application No. 2014-042699 filed on Mar. 5, 2014 and Japanese Patent Application No. 2014-042700 filed on Mar. 5, 2014. The entire disclosure of Japanese Patent Application Nos. 2014-042699 and 2014-042700 is hereby incorporated herein by reference.

### BACKGROUND

1. Technical Field

The present invention relates to a fax device and a printing device for which it is possible to perform settings for the paper to use using print settings.

2. Related Art

In the past, with devices for performing printing on paper such as a fax device, printing device or the like, paper loaded in a paper feed unit was supplied to the interior of the device, and printing was performed (e.g. see Unexamined Patent Publication No. 2010-42893).

Also, devices are known with which it is possible to set the paper using printing settings, and perform printing. By the user operating an operating panel equipped in the device or an external device and setting the type of paper (paper size, paper type and the like) loaded in each of a plurality of paper feed units, the device performs paper feeding from the paper feed unit in which paper of the paper type set using the printing data is loaded, and performs printings with the parameters according to the set paper type.

### SUMMARY

An object of the present invention is to provide a fax device and printing device which can reduce the burden when the user performs setting of the type of paper to load in a paper feed unit.

To solve the problems noted above, a printing device according to one aspect of the invention comprises an input unit, a paper feed unit, a printing unit, and a control unit. The control unit is configured to record a type of paper received via the input unit as a print setting by a user. The control unit is further configured to, according to a type of paper input from the user via the input unit as the print setting, cause the paper feed unit to feed paper, and cause the printing unit to perform printing on the paper that has been fed. The control unit is further configured to, in a first case where the paper is detected to be loaded in the paper feed unit in a normal state, inquire of the user a type of paper loaded, and is further configured not to perform the same inquiry as with the first case in a second case where the paper is detected to be loaded in the paper feed unit during the print setting using a type of paper different from the type of paper being recorded.

In the aspect of the printing device, the control unit is further configured to, in the second case, perform an inquiry with the type of paper, which is input from the user as the print setting, as a default value, and in the first case, perform an inquiry with the type of paper, which has been recorded, as the default value.

In the aspect of the printing device, the paper feed unit has a plurality of paper placement locations, and the paper placement locations include a first and second paper placement locations. When the paper is loaded in the first paper placement location that is a subject of input by the user via the input unit as the print setting in the second case, the inquiry has, as the default value, the type of paper input from the user. When the paper is loaded in the second paper placement location that is not the subject of input by the user via the input unit as the print setting in the second case, the inquiry has, as the default value, the type of paper that has been recorded.

In the aspect of the printing device, the paper placement locations include a paper feed cassette equipped with a switching mechanism configured to mechanically define one of the paper placement locations, which is selected as a paper feed source by operation of the user.

In the aspect of the printing device, the paper feed unit has a plurality of paper placement locations, the control unit is further configured to detect whether or not the paper is loaded in the paper feed unit, and is further configured not to detect which of the paper placement locations the paper is loaded in. The control unit is further configured to, in the second case, perform the inquiry to the user of the type of paper loaded and a paper placement location, with, as the default value, the type of paper and the paper placement location being used, which is input from the user as the print setting.

In the aspect of the printing device, the paper feed unit has a first paper placement location configured to load a first paper thereon, and a second paper placement location configured not to load the first paper thereon. In the second case for which the first paper is input with the print setting, the control unit is further configured to perform the inquiry with the first paper as the default value when the paper is loaded in the first paper placement location, or the control unit is further configured to perform the inquiry with, as the default value, the type of paper that has been recorded when the paper is loaded in the second paper placement location.

In the aspect of the printing device, the control unit is further configured not to perform an inquiry of the type of paper in the second case when the paper is loaded in the paper feed unit, and is further configured to regard the type of paper input from the user as the print setting as being the paper which is loaded.

In the aspect of the printing device, the paper feed unit has a plurality of paper placement locations. The control unit is further configured not to perform the inquiry for paper which is a subject of input by the user via the input unit as the print setting in the second case, and the control unit is further configured to perform the inquiry for paper which is not the subject of input by the user via the input unit as the print setting in the second case.

In the aspect of the printing device, the paper placement locations include a paper feed cassette equipped with a switching mechanism configured to mechanically define one of the paper placement locations, which is selected as a paper feed source by operation of the user.

In the aspect of the printing device, the paper feed unit has a first paper placement location configured to load a first paper thereon, and a second paper placement location configured not to the first paper thereon. In the second case when the first paper is input with the print setting, the control unit is further configured not to perform the inquiry when the paper is loaded in the first paper placement location, and the control unit is further configured to perform the inquiry when the paper is loaded in the second paper placement location.

In the aspect of the printing device, in a case where paper with an orientation difference that the user has tried to load is detected when the paper with the orientation difference is input by the user as the print setting, the control unit is further configured to guide the user in a loading method of the paper with the orientation difference.

The printing device according to the aspect further comprises a display unit, and the control unit is further configured to perform the inquiry by causing he display unit to display an image.

The printing device according to the aspect further comprises a fax communication unit, and the control unit is further configured to cause the printing unit to perform the printing based on fax data received through the fax communication unit.

A printing device according to another aspect of the invention comprises an input unit, a paper feed unit, the paper feed unit having a plurality of paper placement locations, a printing unit, and a control unit. The control unit is configured to detect that paper is loaded in the paper feed unit, and configured not to detect which of the paper placement locations the paper is loaded in. The control unit is further configured to perform an inquiry to a user of a type of paper loaded and a paper placement location according to detection that paper is loaded in the paper feed unit, and the control unit is further configured to cause, according to a response to the inquiry input from the user via the input unit, the paper placement location included in the response to feed the paper, and cause the printing unit to perform printing on the paper that has been fed.

In the another aspect of the printing device, one of the plurality of paper placement locations is configured to feed the paper as a valid paper placement location at a time. The control unit is further configured to perform the inquiry with, as the default value, the paper placement location, which has been recorded as the valid paper placement location, and the control unit is further configured to record the paper placement location included in the response as the valid paper placement location.

### BRIEF DESCRIPTION OF THE DRAWINGS

Referring now to the attached drawings which form a part of this original disclosure:

FIG. 1 is an external view showing the external appearance of the fax device;

FIG. 2 is a hardware configuration diagram of the fax device;

FIG. 3 is a drawing for describing the settings table recorded in the flash memory 54;

FIGS. 4A-4D are conceptual diagrams for describing the functions of the fax device;

FIG. 5 is a flow chart for describing the print settings executed using the fax device;

FIGS. 6A and 6B are status transition diagrams showing the changes in the UI screen displayed on the display unit 40;

FIGS. 7A and 7B are status transition diagrams showing the changes in the UI screen displayed on the display unit 40;

FIG. 8 is a flow chart showing the process executed by the main controller 50 when paper is loaded in the tray;

FIG. 9 is a flow chart showing the process executed at step S11 in FIG. 8;

FIGS. 10A and 10B are drawings showing the inquiry screen 300 displayed on the display unit 40;

FIG. 11 is a flow chart for describing the printing process (copying process) as one example;

FIGS. 12A-12C are drawings for describing the inquiry process of the second embodiment;

FIG. 13 is a flow chart showing the process executed by the main controller 50 with the inquiry process of the second embodiment;

FIG. 14 is a drawing for describing the paper feed cassette of the third embodiment;

FIG. 15 is a drawing showing the relationship of each tray and the paper size that can be loaded in each tray;

FIG. 16 is a flow chart showing the process executed by the main controller 50 with the inquiry process of the fourth embodiment;

FIGS. 17A-17C are drawings for describing the paper for which there are differences in how it is loaded;

FIG. 18 is a flow chart showing the process executed by the main controller 50 with the fifth embodiment;

FIG. 19 is a drawing showing the explanation screen 400 displayed at step 24 when envelope paper is set;

FIG. 20 is a flow chart showing the inquiry process executed by the main controller 50 with the sixth embodiment;

FIG. 21 is a flow chart showing the process executed by the main controller 50 with the inquiry process of the seventh embodiment;

FIG. 22 is a flow chart showing the process executed by the main controller 50 with the inquiry process of the eighth embodiment; and

FIG. 23 is an external view of the system 110 constituted by the fax device 100 and the mobile terminal 60.

### DETAILED DESCRIPTION OF EXEMPLARY EMBODIMENTS

Following, we will describe embodiments of the invention following the sequence noted below.
1. First embodiment
1-1. Fax device constitution, 1-2. Print settings, 1-3. Inquiry process
2. Second embodiment
3. Third embodiment
4. Fourth embodiment
5. Fifth embodiment
6. Sixth embodiment
7. Seventh embodiment
8. Eighth embodiment
9. Ninth embodiment
10. Tenth embodiment
11. Other embodiments

### 1. First Embodiment

### 1-1. Fax Device Constitution

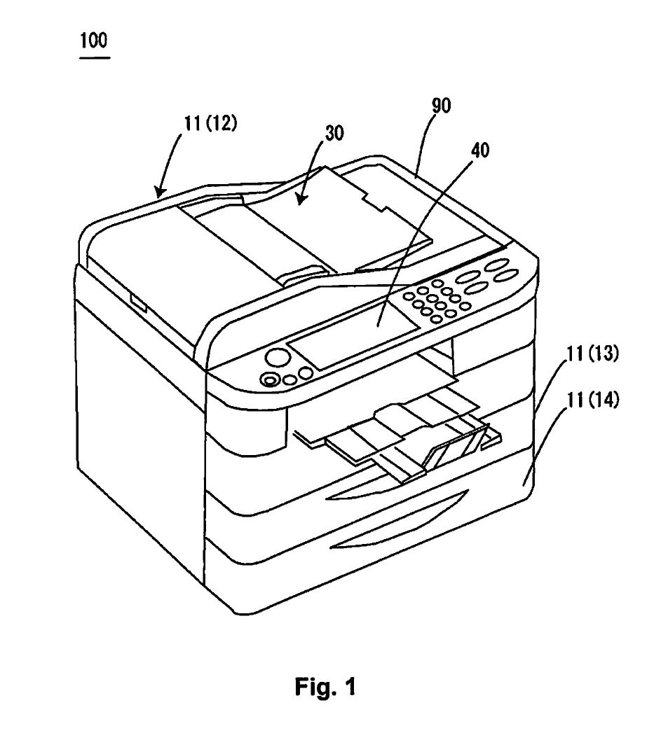

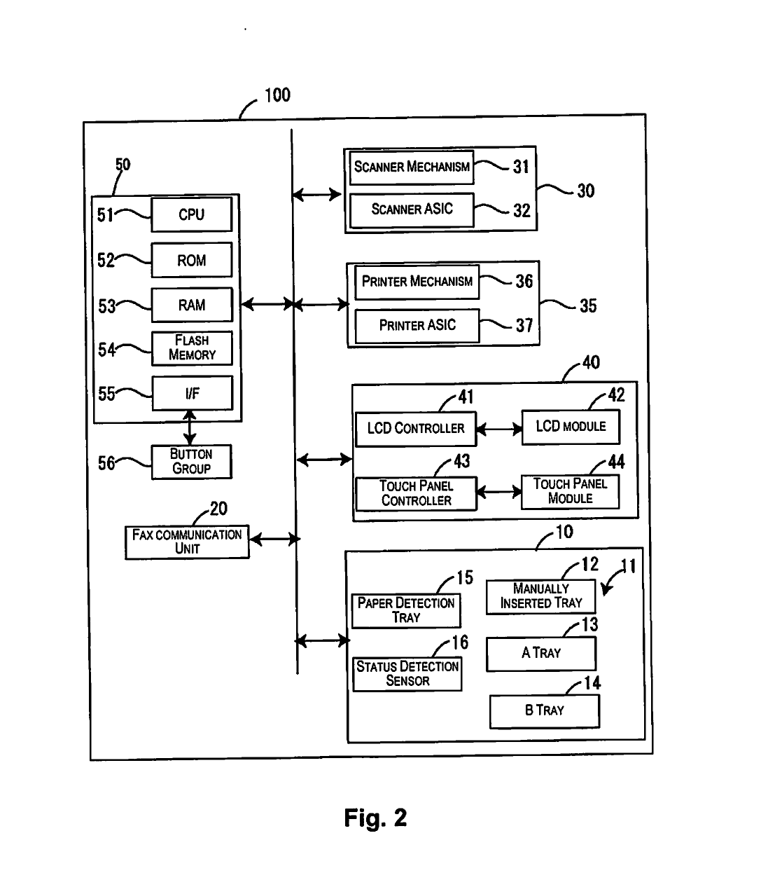

FIG. 1 is an external view showing the external appearance of a fax device. Also, FIG. 2 is a hardware configuration diagram of the fax device.

A fax device 100 is a compound machine including a fax function, printing function, and scanner function. The fax device 100 is equipped with a case 90, a scanner unit 30 equipped on the top part of the case 90, trays (A tray 13, B tray 14) 11 which are a part of a paper feed unit 10 arranged so as to be able to be pulled out from the front surface of the case 90, a tray (manually inserted tray 12) 11 which is a part of the paper feed unit 10 equipped at the back part of the case 90, and a display unit 40 equipped on the front of the case 90 for displaying a screen or receiving the input operation from a user. Also, the hardware shown in FIG. 2 is built into the interior of the case 90.

As shown in FIG. 2, the fax device 100 is equipped with the paper feed unit 10, a fax communication unit 20, a scanner unit 30, a printer unit (printing unit) 35, the display unit 40, and a main controller (control unit) 50. Each part noted above is electrically connected through a bus or the like, and the drive thereof is controlled by the main controller 50.

The fax communication unit 20 performs fax communication with other devices (not illustrated) connected to a network. The network is a telephone line, an internet line, or a line network with these combined. The fax communication unit 20 performs transmission of fax data through the network.

The scanner unit 30 scans a document loaded on a document platform (not illustrated) and converts that into data. Hereafter, the data scanned by the scanner unit 30 is also noted as document data. The scanner unit 30 is equipped with a scanner mechanism 31, and a scanner ASIC 32 for controlling this scanner mechanism 31. The scanner mechanism 31 is a mechanism of the known flatbed type or known ADF (Auto Document Feeder) type.

The paper feed unit 10 is equipped with a paper feed roller (not illustrated), a conveyance roller (not illustrated), a paper placement location (tray 11) for loading paper, a paper detection sensor 15, and a status detection sensor 16. The paper feed unit 10 supplies the paper loaded in the paper placement location (tray 11) using the paper feed roller (not illustrated) and the conveyance roller (not illustrated). Also, for the paper placement locations, provided are the manually inserted tray 12, and cassette types A tray 13 and B tray 14. Following, when collectively naming the manually inserted tray 12, the A tray 13, and the B tray 14, tray 11 is noted. Here, there are three trays, but it is possible to change the number of trays by increasing or removing the number of cassette type trays.

The manually inserted tray 12 is able to have regular paper of fixed sizes such as A4 and B5, as well as non-fixed size paper, and also special paper such as OHP paper and the like loaded in it. Also, the cassette type A tray 13 and B tray 14 can have regular paper of fixed sizes such as A4 and B5 as well as special paper of fixed sizes loaded in them. Specifically, with this embodiment, it is not possible to load non-fixed size paper in the cassette type A tray 13 and the B tray 14.

Equipped in the paper feed unit 10 is a paper detection sensor 15 for detecting that paper is loaded in the manually inserted tray 12, or a status detection sensor 16 for detecting that the position of a paper guide equipped in the tray 11, or the A tray 12 or B tray 14 has been pulled out of or pushed into the case 90. Here, the paper guide is a mechanism that prescribes the size of the paper loaded in the tray 11. Also, the fact that paper has been loaded in the A tray 13 and the B tray 14 is determined by detection by the status detection sensor 16 of the status that the A tray 13 or the B tray 14 having been pushed into the case 90 after being pulled out from the case 90. Of course, the method of detecting that paper has been loaded in the A tray 13 or the B tray 14 is not limited to this, and it is also possible to equip a sensor for detecting that paper has been loaded in the A tray 13 or the B tray 14.

The printer unit 35 performs printing on the paper based on received data received by the fax communication unit 20, printing data sent from the host PC, photographic data stored in a loaded memory card, USB memory or the like, document data scanned by the scanner unit 30 or the like. The printer unit 35 is equipped with a printer mechanism 36 and a printer ASIC 37 that controls this printer mechanism 36. The printer mechanism 36 forms an image based on the printing data generated from the document data on the paper fed by the paper feed unit 10.

The printer mechanism 36 is any mechanism using the known inkjet method or laser method.

The display unit 40 is equipped with an LCD module 42, a touch panel module 44, an LCD controller 41 for controlling the display of the LCD module 42, and a touch panel controller 43 for controlling input of the touch panel module 44. Here, the user can perform operation using the touch panel, but it is also possible to be able to perform the operation using buttons provided separately from the display.

The main controller 50 is constituted as a micro processor that has as the main focus a CPU 51, a ROM 52, a RAM 53, a flash memory 54, and an interface (I/F) 55. Also, by opening and executing in the RAM 53 the various types of programs, various types of data and the like recorded in the ROM 52, the CPU 51 comprehensively controls driving of the fax device 100.

The main controller 50 receives operating signals or the like from a button group 56 via the I/F 55, and receives various types of detection signals from the paper feed unit 10, the fax communication unit 20, the scanner unit 30, the printer unit 35, and the display unit 40. Also, the main controller 50 outputs scan commands (document reading commands) to the scanner unit 30 (scanner ASIC 32), outputs printing commands to the printer unit 35 (printer ASIC 37), and outputs display commands to the display unit 40 (LCD controller 41).

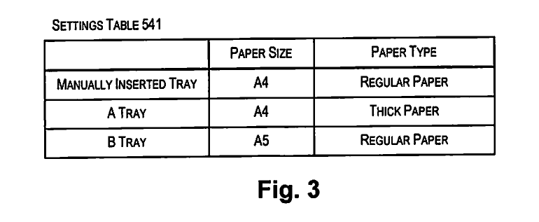

FIG. 3 is a drawing for describing a settings table 541 recorded in the flash memory 54. The settings table 541 is information recording the correspondence relationship of the paper loaded in the paper feed unit 10 and the paper type (paper size, paper type). Here, the paper size is A3, B4, A4, B5 or the like, and the paper type is regular paper, OHP paper, colored paper, thick paper or the like. With the manually inserted tray 12, it is possible to record the size set by the user as the paper size. In the settings table 541, the trays 11 (manually inserted tray 12, A tray 13, B tray 14), the size corresponding to each tray 11, and the paper type are recorded. The main controller 50 determines the type of paper fed from each tray 11 by referencing this settings table 541, determines which tray to feed paper from, and changes the parameters of the printing process executed with the printer unit 35. If the type of paper set as subject to printing is not loaded in any of the trays, a report to that effect is given, and a prompt is given to load the paper. Also, with this embodiment, the type of paper recorded in the settings table 541 can be changed by the user operating the display unit 40.

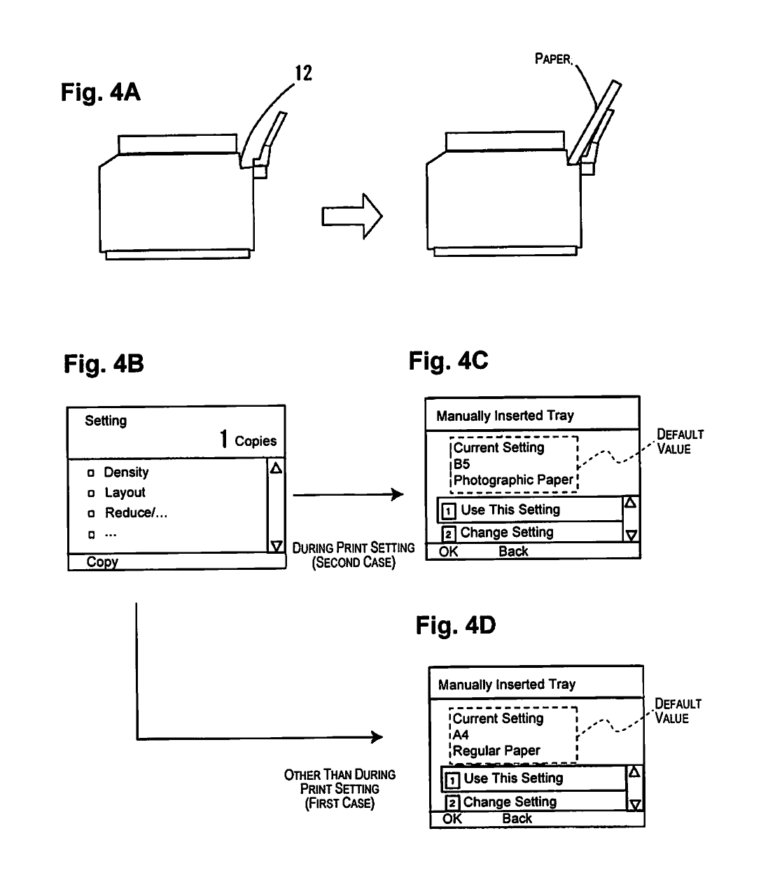

FIGS. 4A-4D are conceptual diagrams for describing the functions of the fax device. Here, using FIGS. 4A-4D, we will describe the inquiry process of the fax device 100 which is particularly related to the invention. In FIGS. 4A-4D, as an example, shown is a change in the inquiry when paper is loaded in the manually inserted tray 12. However, it will be apparent to those skilled in the art from this disclosure that the inquiry process of the fax device 100 is also applicable when paper is loaded in other trays, such as the A tray 13 and the B tray 14.

When it is detected that paper is loaded in the paper feed unit 10 (manually inserted tray 12) (FIG. 4A), the fax device 100 performs the inquiry process that displays the type of paper (paper size, paper type) on the display unit 40. With this inquiry process, the type of paper that is the default value of the inquiry changes according to the status of the fax device 100.

When the user is in the middle of performing print settings setting the paper size to “B5” and the paper type to “Photographic paper” as the print settings (second case), when the user loads paper in the paper feed unit 10, on the screen displayed on the display unit 40 (FIG. 4B), an inquiry screen is displayed with the value for which the default value is set as the print setting, specifically, “B5” and “Photographic paper.” (FIG. 4C). Here, print setting is the process of setting the paper size and paper type of the paper for performing printing for the fax device 100. On the other hand, if the user has not performed print settings for the fax device 100 (first case), as shown in FIG. 4D, when the user loads paper in the paper feed unit 10, the display unit 40 displays an inquiry screen that has the default value as the type of paper recorded up to then. For example, the type of paper recorded up until then is the type of paper recorded in the settings table 541 as the type of paper loaded in the tray the previous time.

In FIG. 4D, “A4” and “Regular paper” which are the paper size and paper type loaded the previous time are displayed on the display unit 40.

By confirming the inquiry default value displayed on the display unit 40, the user can determine whether or not the paper loaded in the paper feed unit 10 is a suitable item for the process thereafter (fax receiving, copying, printing). Of course, after the inquiry process as well, it is possible to change the type of paper by the user operating the display unit 40.

### 1-2. Print Settings

Next, we will describe print settings.

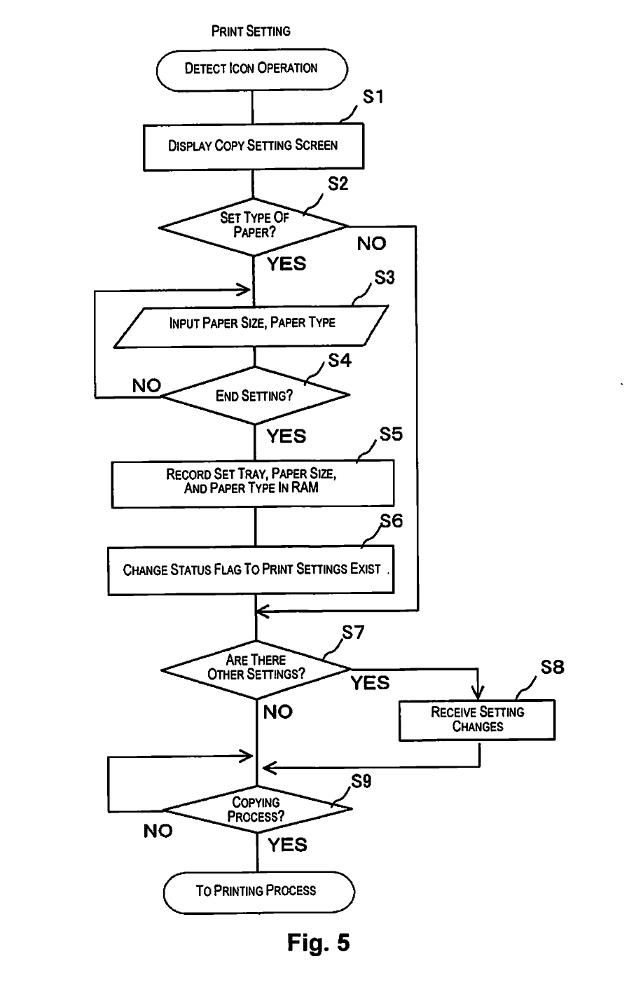

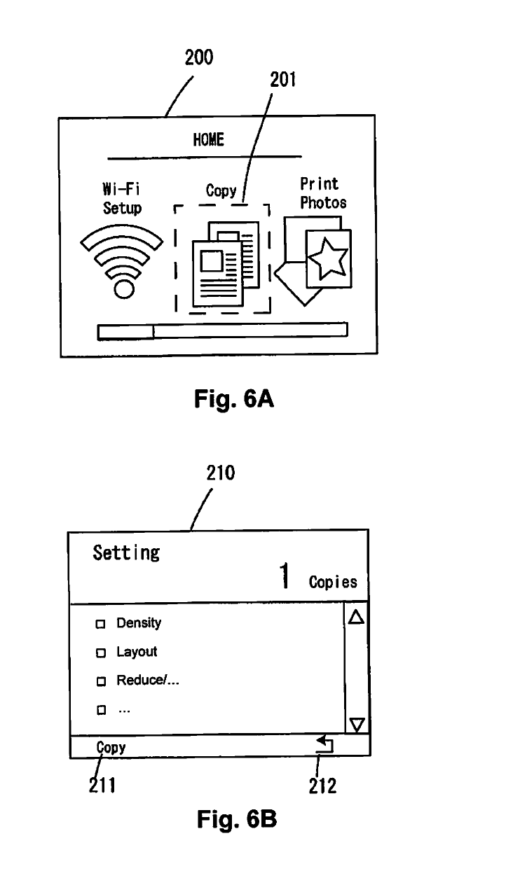

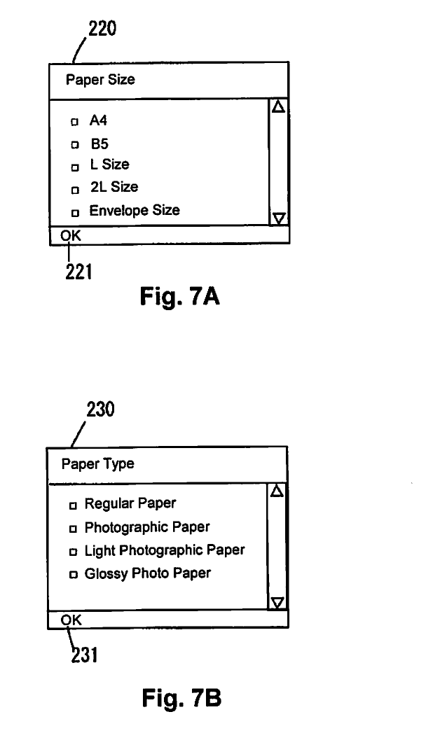

FIG. 5 is a flow chart for describing the print settings executed using the fax device. Also, FIGS. 6A and 6B and FIGS. 7A and 7B are status transition diagrams showing the changes in the UI screen displayed on the display unit 40. We will describe an example when the user sets the type of paper to “B5” and “Photographic paper” for the print settings.

Following, we will describe an example of copy setting as an example of print setting, but the same is also true for other settings (printing process of received data for which a fax is received and stored, printing process of photographic data stored in a loaded memory card, USB memory or the like, or the like).

When the user operates a “Copy” icon 201 of a home screen 200 (FIG. 6A), the main controller 50 detects this, and starts print setting. First, at step S1, the main controller 50 displays a copy setting screen 210 for performing copy setting (FIG. 6B). With this copy setting screen 210, a sub setting screen (FIGS. 7A and B) for performing various settings (number of copies to print, image quality setting, tray, etc.), a copy icon 211 that starts copying, and a back icon 212 that returns to the previous screen are displayed for the fax device 100 to perform copying.

The print setting of this embodiment corresponds to either of when setting the type of paper fed from the specified tray 11 after specifying the tray for feeding paper (manually inserted tray 12, A tray 13, B tray 14), or when setting only the type of paper, and not performing specification of the tray 11. In the latter case, the main controller 50 automatically selects the tray 11 corresponding to the type of paper based on the type of paper that is set. With this first embodiment, either setting method can be handled.

With the copy setting screen 210, when, without operating the back icon 212, the sub setting screen (220 and 230 described later) is displayed and setting of the type of paper or the like is performed (step S2, Yes), at step S3, the main controller 50 receives input.

For example, with the copy setting screen 210, the user specifies the manually inserted tray 12 as the tray 11 for feeding paper, and displays the sub setting screen 220 for changing the paper size shown in FIG. 7A. With this sub setting screen 220, as the paper size fed to the manually inserted tray 12, displayed are the icons “A4,” “B5,” “L size,” “2L size,”, and “Envelope size.”

Also, using the copy setting screen 210, the user specifies the manually inserted tray 12, selects the icon for setting the paper type (not illustrated), and the sub setting screen 230 for changing the paper type shown in FIG. 7B is displayed. With this sub setting screen 230, for example as the paper type fed to the manually inserted tray 12, displayed are the icons “Regular paper,” “Photographic paper,” “Light photographic paper,” and “Glossy photo paper.”

The main controller 50 receives operations from the user for setting the type of paper with the respective sub setting screens 220 and 230 (step S3). Then, when the OK icons 221 and 231 for confirming the settings are operated by the user (step S4, Yes), the main controller 50 records in the RAM 53 the paper size and paper type of the paper loaded in the tray 11 that is feeding the paper (with this example, manually inserted tray 12) (step S5).

When the user operates a cancel icon (not illustrated) that cancels the settings, the main controller 50 does not record the paper size, paper type and the like after changing in the RAM 53.

Also, the setting of the type of paper recorded at step S5 does not update the contents of the settings table 541 recorded in the flash memory 54, and is a value recorded separately from the contents of the settings table 541.

At step S6, the main controller 50 changes the status flag to Print settings exist. The status flag is information for the main controller 50 to determine whether or not print settings have been performed. For example, with the print settings, when tray 11 (with the example above, the manually inserted tray 12) is specified, the status flag corresponding to that tray 11 changes to a value indicating that Print settings exist (hereafter also noted as during print setting). Also, with the print settings, if the tray 11 is not specified, there is a change to a status flag common to trays 12 through 14.

Furthermore, it is also possible to receive operation from the user through a separate sub setting screen for other settings such as enlargement or reduction settings, print quality settings or the like. Specifically, when the user performs the operation of having a sub setting screen for each setting displayed from the copy setting screen 210 (step S7, Yes), the main controller 50 displays a sub setting screen (not illustrated) and receives the operation from the user (step S8).

Then, when the user operates the copy icon 211 (step S9, Yes), the main controller 50 starts the copying process (printing process). On the other hand, when the user loads paper in the tray 11 without operating the copy icon 211, the main controller 50 starts the inquiry process. With this first embodiment, the inquiry process is started when the paper is loaded in any of the trays 11.

### 1-3. Inquiry Process

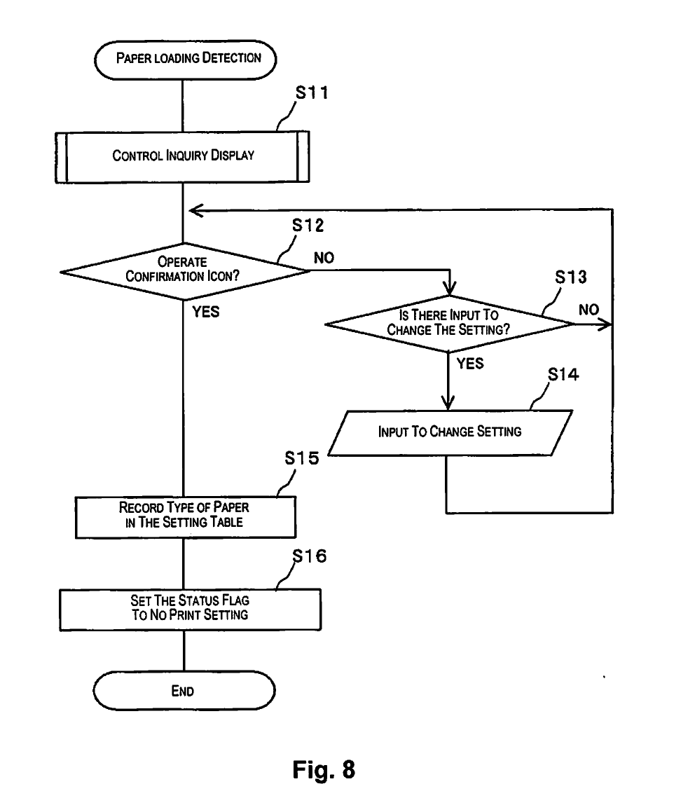

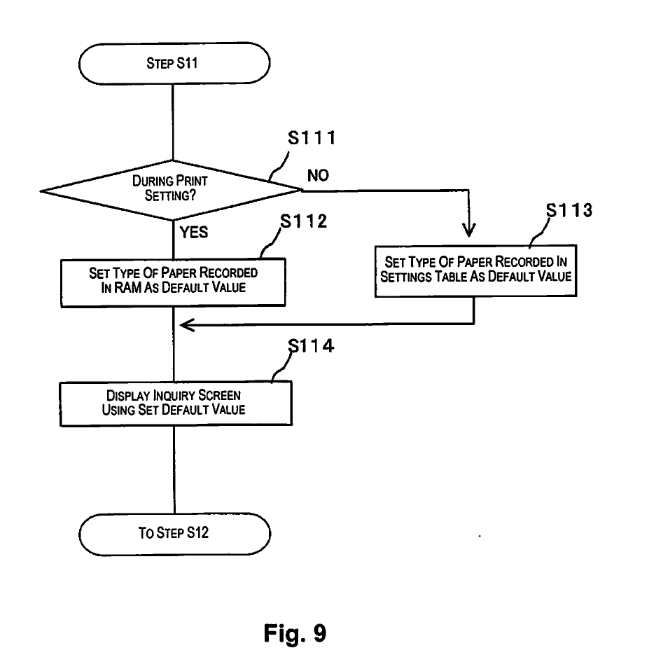

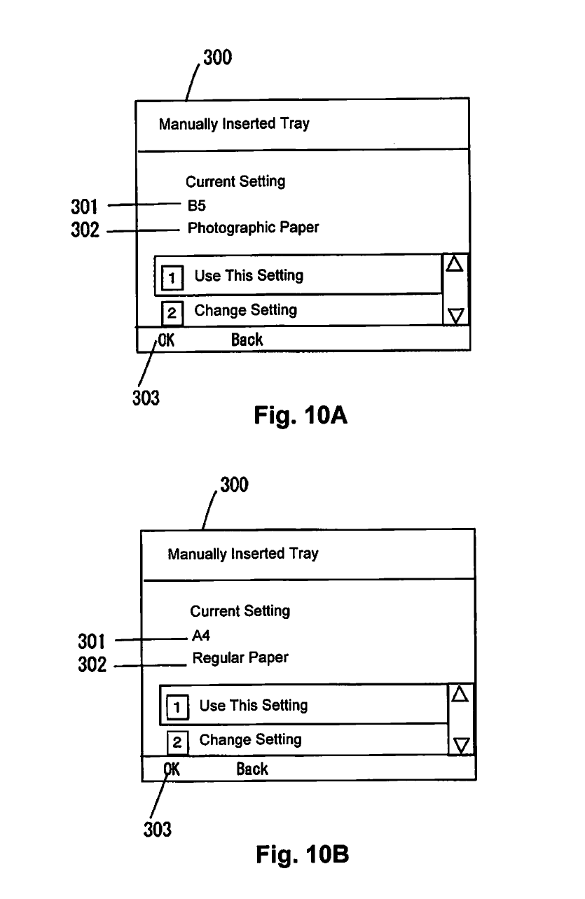

Next, we will describe the inquiry process executed when paper is loaded in the paper feed unit 10. FIG. 8 is a flow chart showing the process executed by the main controller 50 when paper is loaded in the tray. Also, FIG. 9 is a flow chart showing the process executed at step S11 in FIG. 8. Then, FIGS. 10A and 10B are drawings showing the inquiry screen 300 displayed on the display unit 40.

When the user loads paper in any of the trays 11, the main controller 50 detects that the paper has been loaded, and starts the inquiry process. For example, the main controller 50 detects that paper has been loaded in the manually inserted tray 12 by changing the detection signals output from the paper detection sensor 15. Also, the main controller 50 detects that paper has been loaded in the A tray 13 or the B tray 14 by changes in the detection signals from the status detection sensor 16 that occur with pulling out or pushing in of the A tray 13 or the B tray 14 with the case 90. With this first embodiment, even when the user loads paper in the tray 11, the main controller 50 starts the inquiry process.

At step S11, the main controller 50 performs control of the inquiry display. The control of the inquiry display implemented at step S11 is the process for displaying the inquiry screen 300 shown in FIGS. 10A and 10B.

Using FIG. 9, we will describe the control of the inquiry display performed at step S11 of FIG. 8.

At step S111, the main controller 50 references the status flag, and if there were changes to the status flag during print setting (step S111, Yes), the process advances to step S112. At step S112, the main controller 50 sets the type of paper recorded in the RAM 53 (recorded at step S5 in FIG. 5) as the inquiry default value.

On the other hand, if the status flag has not changed (in other words, it is not during print setting) (step S111, No), the main controller proceeds to step S113. At step S113, the main controller 50 uses the type of paper set in the settings table 541 in the tray 11 in which the paper is loaded as the default value. Of course, the default value of the type of paper for step S113 is not limited to this.

At step S114, the main controller 50 displays the inquiry screen on the display unit 40 based on the default value (paper size, paper type) set at step S112 or step S113. Because of that, the inquiry screen 300 shown in FIG. 10A is displayed on the display unit 40.

In FIGS. 10A and 10B, as an example, shown is the inquiry screen 300 displayed during the inquiry process executed when paper is loaded in the manually inserted tray 12. However, it will be apparent to those skilled in the art from this disclosure that display of the inquiry screen 300 is also applicable when paper is loaded in other trays, such as the A tray 13 and the B tray 14. FIG. 10A is a drawing showing the inquiry screen 300. On this inquiry screen 300 are respectively displayed a default value 301 of the paper size, a default value 302 of the paper type, and a confirmation icon 303 for starting the copying process.

For comparison, FIG. 10B is a drawing showing the inquiry screen 300 when the status flag has not changed (specifically, when not during print setting). In FIG. 10B, “A4” is shown as the paper size default value 301, and “Regular paper” is shown as the paper type default value 302. For example, “A4” and “Regular paper” are the paper size and paper type set in the manually inserted tray 12 that were set in the settings table 541 until then (until the paper was loaded).

Returning to FIG. 8, at step S12, when the user operated the confirmation icon 303 of the inquiry screen 300 (step S12, Yes), at step S15, the main controller 50 records in the settings table 541 the type of paper displayed on the inquiry screen 300 as the paper of the tray in which paper is loaded (in FIG. 10A, “B5” and “Photographic paper”).

On the other hand, when the user does not operate the confirmation icon 303 (step S12, No), and inputs an operation to change the type of paper (step S13, Yes), at step S14, the main controller 50 receives the change input for the type of paper. At step S14, for example, the copy setting screens 220 and 230 shown in FIGS. 7A and 7B are displayed on the display unit 40. With this copy setting screen, the user can change the type of paper.

Returning to step S12, when the user operates the confirmation icon 303 (step S12, Yes), at step S15, the main controller 50 records the type of paper after the change in the settings table 541 as the paper of the tray 11 in which paper has been loaded. Also, at step S16, the main controller 50 sets the status flag to No print setting.

Next, we will describe the printing process (copying process).

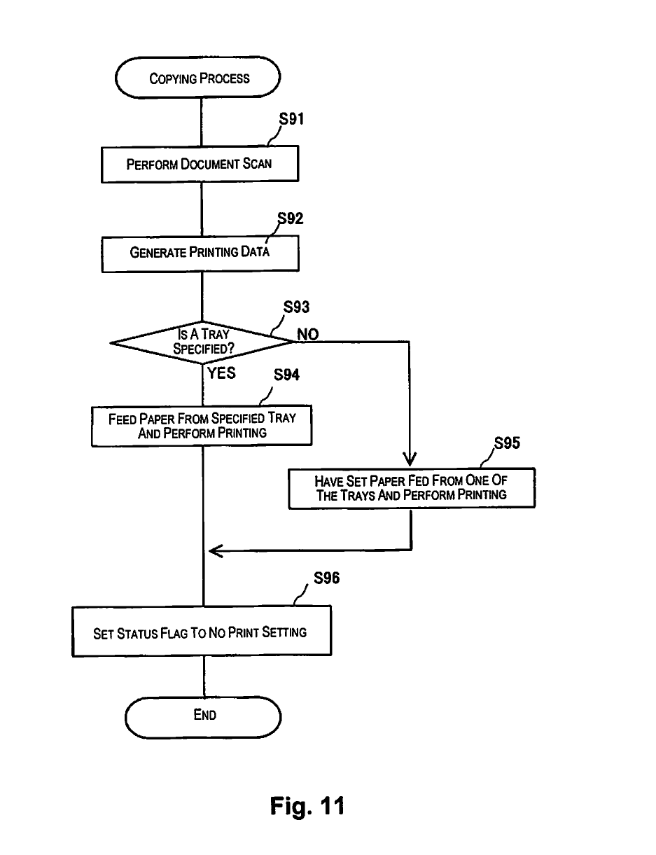

FIG. 11 is a flow chart for describing the printing process (copying process) as one example. When the user operates the copy icon 211 (e.g. step S9 in FIG. 5, Yes), the main controller 50 proceeds to the copying process.

At step S91, the main controller 50 controls the scanner unit 30, and starts scanning the document loaded on the document platform. Then, the document data read by the scanner unit 30 is output to the printer unit 35. At step S92, the main controller 50 controls the printer unit 35, and generates printing data using the parameters according to the print settings (type of paper, other settings) based on the input document data.

After that, if the tray 11 is specified with the print settings (step S93, Yes), at step S94, the main controller 50 has paper fed from the specified tray 11 and performs printing. At this time, the main controller 50 references the settings table 541 to check whether the paper of the paper type set with the print settings is loaded in the specified tray 11. If the paper of the settings has been loaded, the main controller 50 has paper fed from that tray 11, and has the printer unit 35 perform printing using the printing data. On the other hand, if the paper of the settings is not loaded, the main controller 50 performs an error display, and prompts the user to load the paper of the settings in the specified tray.

Also, if the tray 11 has not been specified with the print settings (step S93, No), at step S95, the main controller 50 has printing performed by the printer unit 35 using paper loaded in any of the trays 11. At this time, the main controller 50 references the settings table 541 to check whether the type of paper set with the print settings is loaded in any of the trays 11. If the set paper is loaded in any of the trays 11, the main controller 50 has paper fed from the tray 11 in which the set paper has been loaded, and has the printer unit 35 perform printing using the printing data. If the paper of the type of paper that was set has not been loaded, the main controller 50 performs an error display, and prompts the user to load the paper that was set into one of the trays 11.

Then, at step S96, the main controller 50 sets the status flag to No print setting, and ends the processing.

As described above, with this first embodiment, when the device is currently in print setting, when loading paper in the tray 11, the device performs an inquiry with the type of paper set with the print settings as the default value. Specifically, with the inquiry, if the paper that was set in advance with the print settings is the default value, it is possible to confirm the settings as is. On the other hand, when print settings have not been performed, the type of paper that had been recorded up to then is used as the default value.

Because of that, the type of paper that was set is reflected as the default value only when print settings are not performed, so it is possible to reduce the burden when the user loads the paper.

Also, by performing the inquiry process, it is possible for the user to determine when the loaded paper is different from the default value, and possible to prevent printing when there is a paper loading error.

### 2. Second Embodiment

With this second embodiment, with the inquiry process, the constitution for the default value of the type of paper displayed on the inquiry screen 300 to change according to the tray 11 in which the paper is loaded is different from the first embodiment. In particular, with this second embodiment, the case of the tray for feeding paper (manually inserted tray 12, A tray 13, B tray 14) being specified with the print settings is different from the first embodiment.

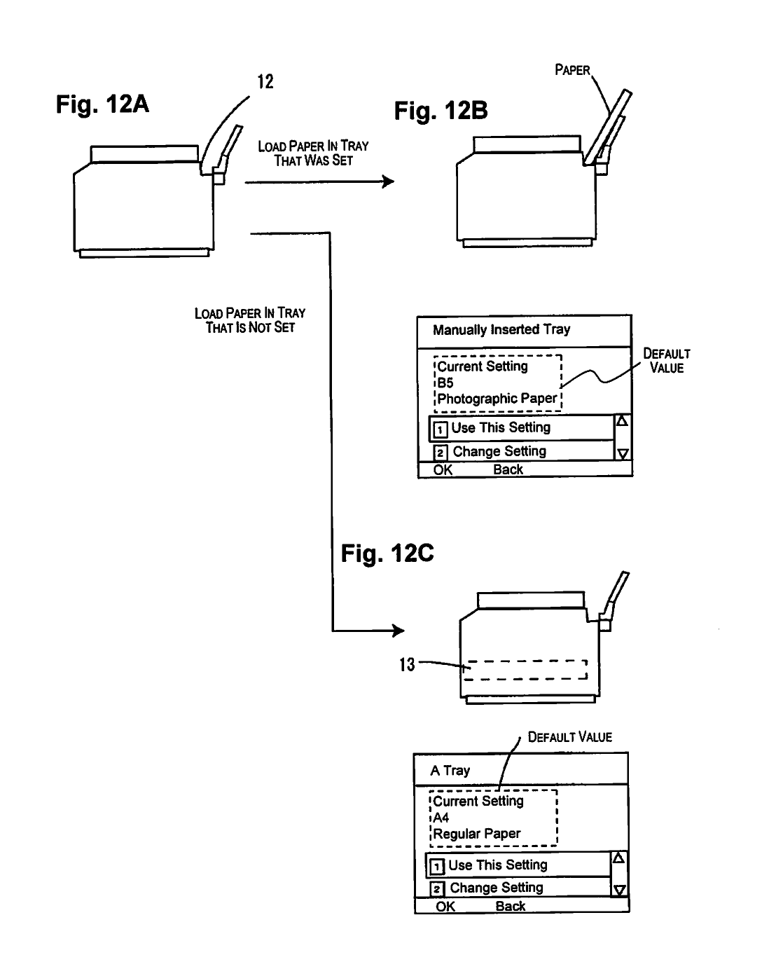

FIGS. 12A-12C are drawings for describing the inquiry process of the second embodiment. FIG. 12A shows the inquiry screen 300 displayed when paper is loaded in the tray 11 set with the print setting process. Also, FIG. 12B shows the inquiry screen 300 displayed when paper is loaded in the tray 11 other than the tray 11 set with the print setting process.

For example, we will describe a case when in a state when “A4” and “Regular paper” are recorded in correspondence to all the trays 11, and paper has not been loaded (FIG. 12A), the user uses print settings to specify use of the manually inserted tray 12 and “B5” and “Photographic paper.” When the user loads paper in the manually inserted tray 12 (tray set during print setting) during print setting (FIG. 12B), the type of paper set with the print settings (“B5” and “Photographic paper”) are used as the default value. On the other hand, when the user loads paper in the A tray 13 (tray not set during print setting) during print setting (FIG. 12C), the inquiry uses the type of paper recorded up until then (“A4” and “Regular paper”) as the default value.

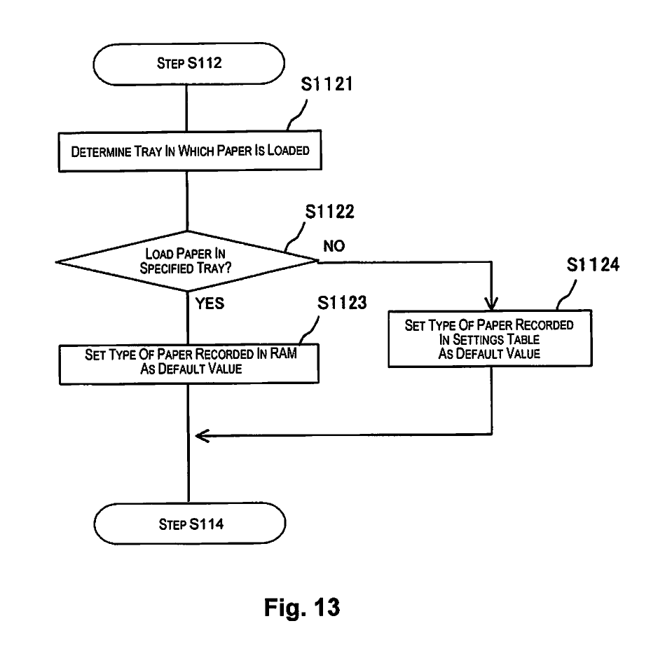

FIG. 13 is a flow chart showing the process executed by the main controller 50 with the inquiry process of the second embodiment. The flow chart shown in FIG. 13 is the process executed with step S112 of FIG. 9 when the tray for feeding paper has been specified with the print setting. The process other than that shown in FIG. 13 is the same as that of the first embodiment, so we will describe this using FIG. 8 through FIGS. 10A and 10B.

When the user loads paper in the tray 11, the main controller 50 detects that paper has been loaded, and starts control of the inquiry display shown in step S11 in FIG. 8. Then, the main controller 50 detects a change in the status flag (FIG. 9, step S111, Yes), and proceeds to step S112.

With step S1121 of FIG. 13, the main controller 50 determines the tray 11 in which paper is loaded. For the method of the main controller 50 detecting that paper has been loaded in the tray 11, it is possible to use the same method as that of the first embodiment.

If the tray 11 in which paper has been loaded is the tray 11 specified with the print settings (step S1122, Yes), the main controller 50 proceeds to step S1123. For example, if feeding paper from the manually inserted tray 12 is specified, and the main controller 50 detects that paper has been loaded in the manually inserted tray 12, the process proceeds to step S1123.

At step S1123, the main controller 50 sets the type of paper recorded in the RAM 53 (recorded at step S5 in FIG. 5) as the inquiry default value.

On the other hand, if the tray 11 in which paper has been loaded is not the tray 11 specified with the print settings (step S1122, No), then the main controller 50 proceeds to step S1124. For example, if the manually inserted tray 12 is specified with the print settings, and the main controller 50 detects that paper is loaded in the A tray 13 or the B tray 14, it proceeds to step S1124. Then, at step S1124, the main controller 50 references the settings table 541, and the type of paper set for that tray (with this example, the A tray 13 or the B tray 14) is set as the default value.

Following, at step S114 in FIG. 9, the main controller 50 has the inquiry screen 300 displayed on the display unit 40 based on the default value of the type of paper that was set. Specifically, the default value of the type of paper for the inquiry changes according to whether or not paper has been loaded in the tray for feeding paper with the print settings.

When the user operates the confirmation icon 303 of the inquiry screen 300 (FIG. 8, step S12, Yes), the main controller 50 records the type of paper displayed on the inquiry screen 300 in the settings table 541 (step S15). Then, at step S16, the main controller 50 sets the status flag to No print setting.

On the other hand, when the user does an operation to change the type of paper (FIG. 8, step S13, Yes), the main controller 50 receives input to change the paper type (step S14).

As described above, with this second embodiment, when the tray 11 for feeding paper is specified, and paper is loaded in the set tray 11, an inquiry is performed using the type of paper set with the print settings as the default value. Because of that, even when the tray 11 is specified with the print settings, the same effects are exhibited as with the first embodiment.

### 3. Third Embodiment

With this third embodiment, when using the tray 11 (paper feed cassette) that can make individual trays by switching the internal space using the switching mechanism, the constitution for changing the inquiry process default value for each switched paper placement location differs from the other embodiments.

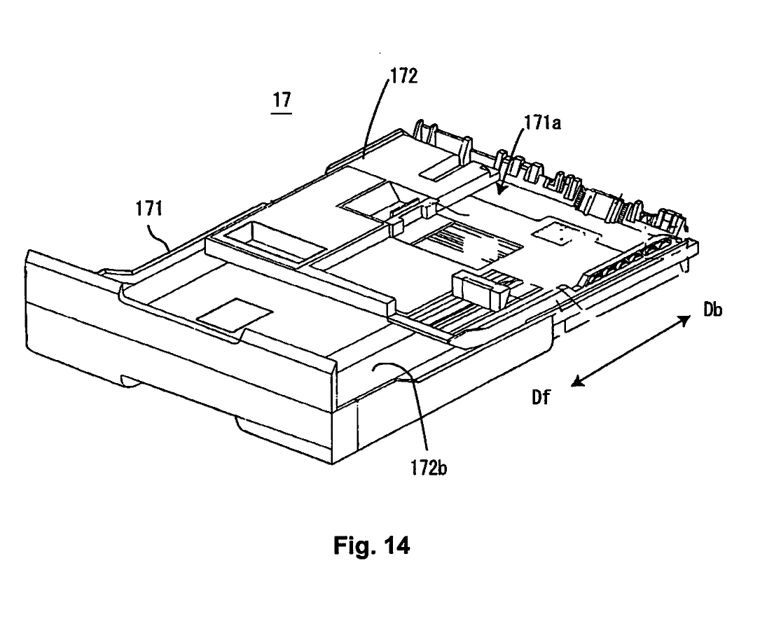

FIG. 14 is a drawing for describing the paper feed cassette of the third embodiment. For example as a detailed description of this type of paper feed cassette, there is Unexamined Patent Publication No. 2010-42893.

The paper feed cassette 17 is equipped with a main unit 171, a switching mechanism 172 fixed so as to be able to slide inside the main unit 171, and a sensor (not illustrated) for detecting status changes of the switching mechanism 172. Then, an upper side upper paper placement location 171a and a lower side lower paper placement location 171b are formed sandwiching the switching mechanism 172 on the interior of the main unit 171.

In a state with the switching mechanism 172 slid to the back direction Db in the drawing in relation to the main unit 171, the paper loaded in the upper paper placement location 171a is fed. Also, in a state with the switching mechanism 172 slid to the front direction Df in the drawing in relation to the main unit 171, the paper loaded in the lower paper placement location 171b is fed. Then, the sensor detects a status change in the switching mechanism 72, and detection signals according to the position of the switching mechanism 172 are output to the main controller 50. Also, paper detection sensors for detecting the respective papers are not attached to the upper paper placement location 171a and the lower paper placement location 171b, paper feeding is attempted, and a determination is made of whether paper has actually been fed according to the presence or absence of paper.

Even in a case when the fax device 100 is equipped with this kind of paper feed cassette 17, it is possible to handle in the same manner as the embodiments noted above as paper having been loaded in the paper placement location of the side at which paper feeding is possible. For example, when the upper paper placement location 171a is specified as the tray with the print settings, the main controller 50 executes the inquiry process shown in FIG. 13 in accordance with the paper having been loaded. With this inquiry process, when the paper feed cassette 17 is loaded in a state with the switching mechanism 172 slid to the back direction Db in the drawing in relation to the main unit 171 (FIG. 13, step S1122, Yes), the inquiry is made of the paper loaded in the upper paper placement location 171a with the type of paper of the print setting recorded in the RAM as the default value of the inquiry (FIG. 13, step S1123). Then, in accordance with the user having ended input, the type of paper shown on the inquiry screen is stored in the settings table 541 as the type of paper loaded in the upper paper placement location 171a.

On the other hand, when the paper feed cassette 17 is loaded in a state with the switching mechanism 172 slid to the front direction Df in the drawing in relation to the main unit 171 (FIG. 13, step S1122, No), an inquiry is made of the paper loaded in the lower paper placement location 171b with the type of paper stored as the paper loaded in the lower paper placement location 171b with the settings table 541 up until then as the inquiry default value (FIG. 13, step S1124). Then, in accordance with the user having ended input, the type of paper shown in the inquiry screen is stored in the settings table 541 as the type of paper loaded in the lower paper placement location 171b.

As described above, with this third embodiment, even when individual paper placement locations are set with one paper feed cassette by changing the mechanism, it is possible to apply the invention.

### 4. Fourth Embodiment

With this fourth embodiment, when there is a difference in the paper that can be loaded for each tray 11 with the print settings, the constitution for changing the inquiry default value according to the paper set with the print settings differs from the other embodiments. Also, with this fourth embodiment, the subject is cases when the main controller 50 automatically selects the tray 11 without the user specifying the tray 11 for feeding paper with the print settings. Of course, it is also possible to select by the user specifying the tray for feeding paper, and possible to have it only possible for the main controller 50 to automatically select the tray 11 when it is not possible for the user to specify the tray for feeding paper.

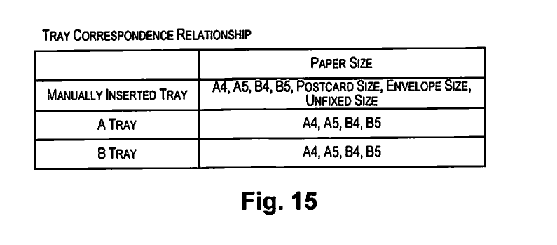

FIG. 15 is a drawing showing the relationship of each tray and the paper size that can be loaded in each tray. With the example shown in FIG. 15, for the manually inserted tray 12, fixed sizes (A4, A5, B4, B5, postcard size, envelope size) and unfixed sizes (user defined size) can be loaded (paper fed). Also, with the A tray 13 and the B tray 14, only a portion of the fixed sizes (A4, A5, B4, B5) can be loaded (paper fed).

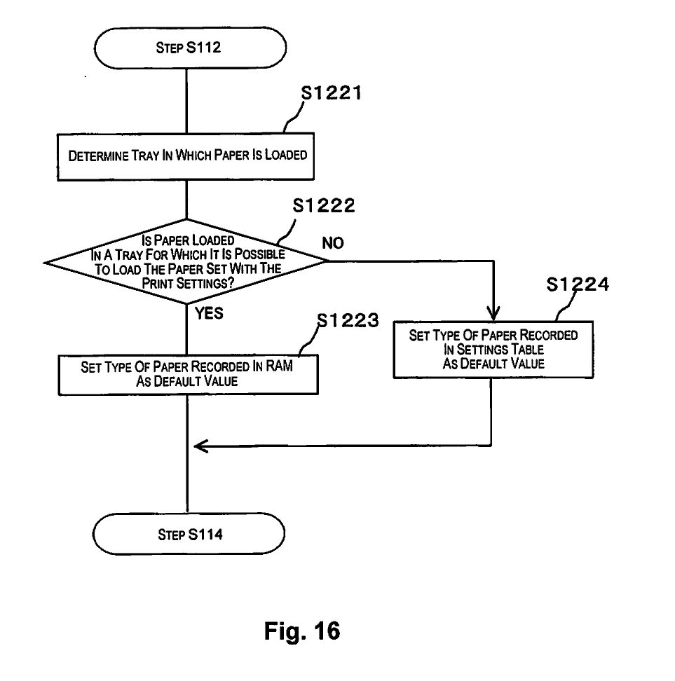

FIG. 16 is a flow chart showing the process executed by the main controller 50 with the inquiry process of the fourth embodiment. The flow chart shown in FIG. 16 is the process executed at step S112 in FIG. 9. With the description hereafter, “Envelope size” is set as the paper size. The process other than that shown in FIG. 16 is the same as that of the first embodiment, so we will describe that using FIG. 8 through FIG. 10B.

When the user loads paper in the tray 11, the main controller 50 detects that paper has been loaded, and starts control of the inquiry display shown in step S11 in FIG. 8. Then, the main controller 50 detects a change in the status flag (FIG. 9, step S111, Yes), and proceeds to step S112.

At step S1221 in FIG. 16, the main controller 50 determines the tray 11 in which paper is loaded. For example, the main controller 50 detects that paper is loaded in the manually inserted tray 12 in accordance with changes in the detection signals from the paper detection sensor 15. Also, the main controller 50 detects that paper has been loaded in the A tray 13 or the B tray 14 in accordance with changes in the detection signals from the status detection sensor 16.

If the tray 11 in which the paper is loaded corresponds to the type of paper set with the print setting (step S1222, Yes), the main controller 50 proceeds to step S1223. The main controller 50 records the corresponding relationship between each tray 11 shown in FIG. 15 and the type of paper. Because of that, for example, with print settings, when set to feed “Envelope size” paper, if the main controller 50 determines that paper has been loaded in the manually inserted tray 12 (step S1221), it proceeds to step S1223.

At step S1223, the main controller 50 sets the type of paper with the print setting recorded in RAM 53 (recorded at step S5 in FIG. 5) as the inquiry default value.

Meanwhile, if the tray 11 in which the paper is loaded does not correspond to the type of paper set with the print settings (step S1222, No), the main controller 50 proceeds to step S1224. For example, if the main controller 50 determines that paper is loaded in the A tray 13 or the B tray 14 that does not correspond to “Envelope size” (step S1221), it proceeds to step S1224. Then, at step S1224, the main controller 50 references the settings table 541, and the type of paper set for that tray (with this example, A tray 13 or B tray 14) is set as the default value.

Following, at step S114 in FIG. 9, the main controller 50 displays the inquiry screen 300 on the display unit 40 based on the set paper type default value. Specifically, the paper type default value for the inquiry changes according to whether or not paper corresponding to the paper set with the print settings has been loaded in the tray 11.

Following, when the user operates the confirmation icon 303 of the inquiry screen 300 (FIG. 8, step S12, Yes), the main controller 50 records the type of paper with the inquiry screen 300 as the type of paper loaded in the tray 11 in the settings table 541 (step S15). On the other hand, when the user does an operation to change the type of paper (FIG. 8, step S13, Yes), the main controller 50 receives input to change the paper type (step S14).

As described above, with this fourth embodiment, when a paper is set with the print settings for which it is possible to load only in a specific tray 11, the inquiry default value is changed when paper is loaded in the tray 11 which can feed this paper, and when loaded in the tray 11 that cannot feed it. Because of that, it is possible to suppress printing errors due to paper loading errors.

### 5. Fifth Embodiment

With this fifth embodiment, when paper for which there is a difference in loading direction is set with the print settings, the constitution by which the paper loading method is notified ahead of the inquiry process is different from that of the other embodiments.

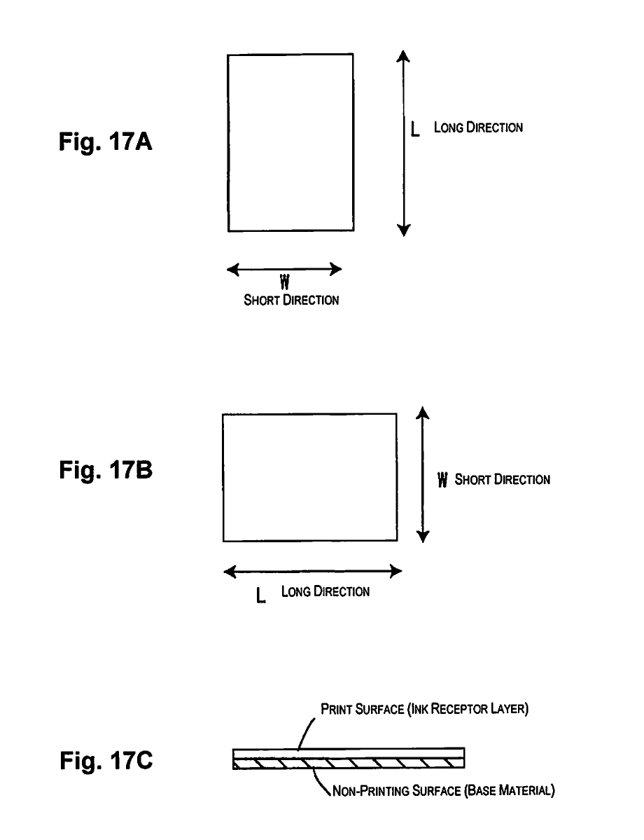

FIGS. 17A-17C are drawings for describing paper for which there is a loading difference. Envelope paper is shown as an example of paper for which there is a loading difference in FIGS. 17A and 17B. Also, OHP paper is shown as an example of paper for which there is a loading difference in FIG. 17C.

As shown in FIGS. 17A and 17B, the envelope paper has a long direction side (length L) and a short direction side (length W). When printing text with the long direction side vertical in relation to the envelope paper, the paper size is set to “Envelope size” and the printing direction is set to “Vertical direction” with the print settings. Also, when loading envelope paper in the manually inserted tray 12, the long direction side is loaded along the paper feeding direction of the manually inserted tray 12.

Also, when printing text with the short direction side vertical in relation to the envelope paper, the paper size is set to “Envelope size” and the printing direction is set to “Horizontal direction” with the print settings. Then, when the envelope paper is loaded in the manually inserted tray 12, the short direction side is loaded along the paper feed direction of the manually inserted tray 12.

Also, as shown in FIG. 17C, special paper such as OHP paper or the like has a printing surface (ink receptive layer) and a non-printing surface (base material). For example, when printing on OHP paper, the paper type is set to “OHP paper” with the print settings. Then, when loading the OHP paper in the manually inserted tray 12, as shown in FIG. 17C, the printing surface is loaded facing the front (facing the back with some devices). Though the description is omitted here, for the loading orientation, we also assume cases when there is a combination of the two items of paper vertical/horizontal and front/back.

With this embodiment, as noted above, when loading paper that has a loading difference with the print settings, a screen for describing the paper loading direction is displayed ahead of the inquiry process.

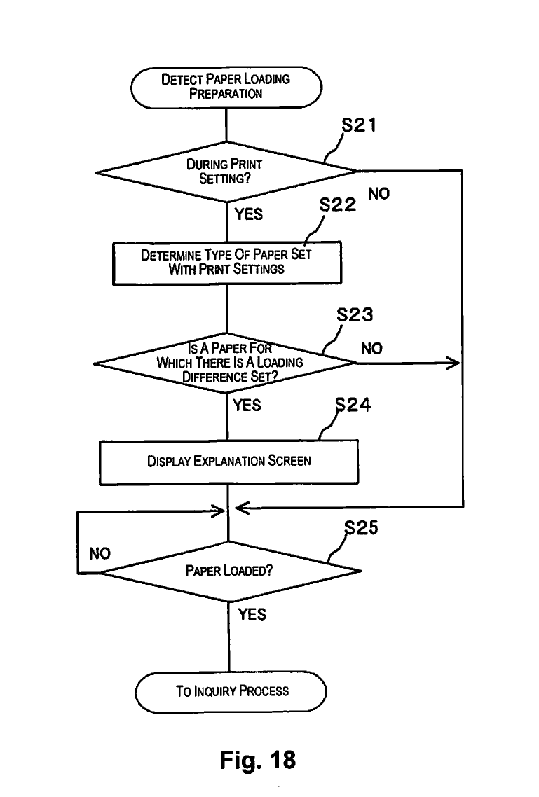

FIG. 18 is a flow chart showing the process executed by the main controller 50 with the fifth embodiment. The flow chart shown in FIG. 18 is executed when the main controller 50 detects that the user is attempting to load paper. Examples of this are when the guide position of the tray 11 is changed, or when the A tray 13 or the B tray 14 is pulled out from the case 90, and a detection signal is output from the status detection sensor 16.

Besides this as well, it is also possible for the main controller 50 to detect that an attempt has been made to load paper when it detects that the status flag has changed during print setting without paper being loaded in the tray 11.

At step S21, the main controller 50 references the status flag of the tray 11, and if the status flag has changed during print setting (step S21, Yes), it proceeds to step S22. On the other hand, if the status flag has not changed (specifically, not during print setting) (step S21, No), the main controller 50 proceeds to step S25.

At step S22, the main controller 50 determines the type of paper set with the print settings. With the type of paper recorded in the RAM 53, if paper that has a loading difference is set (step S23, Yes), then at step S24, the main controller 50 displays on the display unit 40 an explanation screen 400 for notifying the paper loading direction orientation.

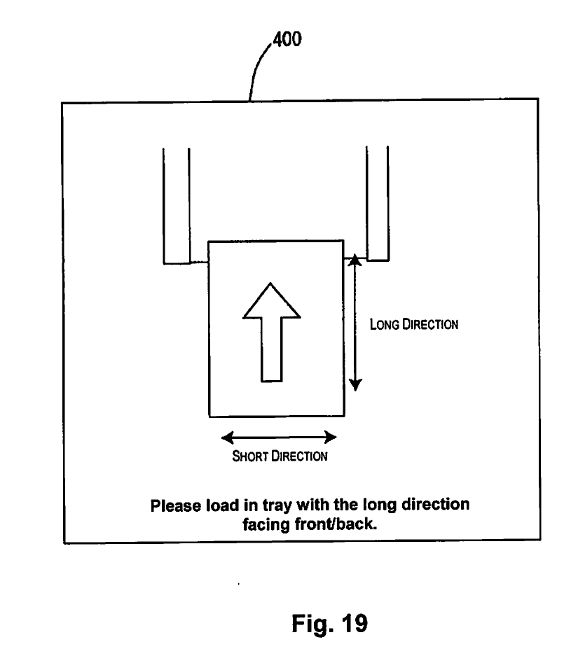

FIG. 19 is a drawing showing the explanation screen 400 displayed at step 24 when envelope paper is set.

On this explanation screen 400 is displayed a screen for which the paper long direction side is loaded along the paper feed direction of the manually inserted tray 12. Of course, the explanation screen shown in FIG. 19 is merely an example, and the explanation can be changed as appropriate according to the tray 11 in which paper is loaded. Also, though not illustrated, when OHP paper is set with the print settings, an explanation screen for explaining the front and back of the OHP paper when loading in the tray 11 is displayed.

On the other hand, if paper which does not have a loading difference is set for the type of paper recorded in the RAM 53 (step S23, No), the main controller 50 proceeds to step S25 without displaying the explanation screen 400.

After that, when the main controller 50 detects that paper has been loaded (step S25, Yes) the inquiry process is started. With the inquiry process, as shown with the other embodiments, an inquiry screen is displayed that inquires about the paper loaded in the tray 11.

As described above, with this fifth embodiment, when paper for which there is a difference in loading direction is set with the print settings, an explanation screen is displayed ahead of the inquiry, so it is possible to suppress errors when the user loads paper in the tray 11.

### 6. Sixth Embodiment

It is also possible to perform the inquiry process only with the first case for which print settings have not been performed, without performing the inquiry process with the second case during printing setting.

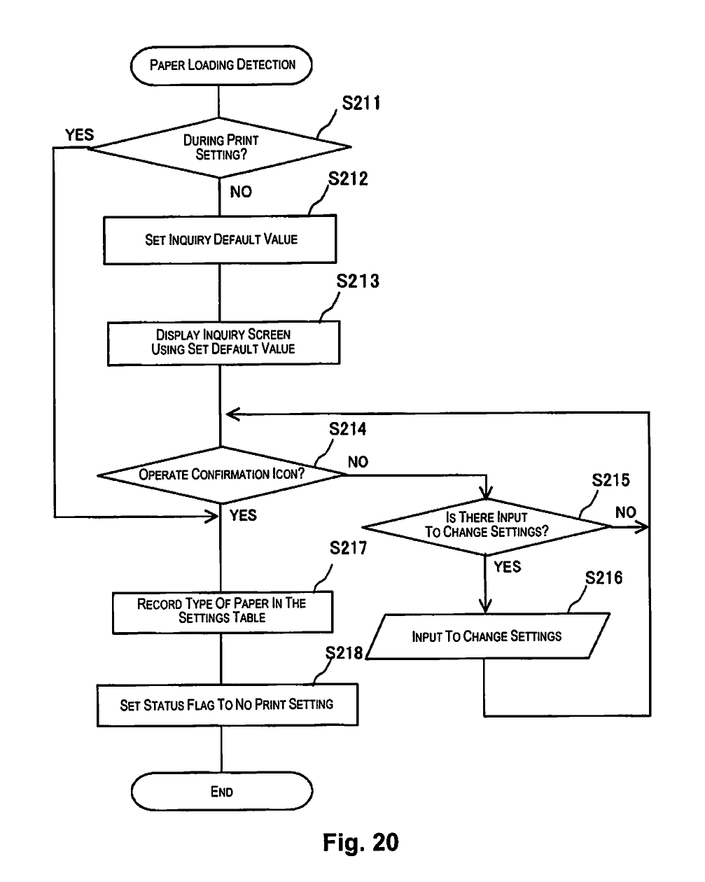

FIG. 20 is a flow chart showing the inquiry process executed by the main controller 50 with the sixth embodiment.

With this sixth embodiment, even if the user loads paper in trays 12 to 14, the main controller starts the inquiry process.

When the user loads paper in any tray 11, the main controller 50 detects that paper has been loaded, and starts the inquiry process shown in FIG. 20. At step S211, the main controller 50 references the status flag of the tray 11, and if the status flag has changed during print setting (step S211, Yes), it proceeds to step S217. Specifically, if during print setting, the main controller 50 does not perform an inquiry. At step S217, the main controller 50 records the type of paper loaded using the print settings in the settings table 541 as the paper set in the tray 11. At step S218, the main controller 50 sets the status flag to No print setting.

On the other hand, if there is no change in the status flag (specifically, not during print setting) (step S211, No), the main controller 50 proceeds to step S212. At step S212, the main controller 50 sets the inquiry default value. For example, it sets the type of paper set in the settings table 541 for the tray 11 in which paper is loaded as the default value. Of course, setting the type of paper at step S212 is not limited to this.

At step S213, the main controller 50 displays the inquiry screen on the display unit 40 based on the default value (paper size, paper type) set at step S212. Specifically, if not during print setting, the main controller 50 performs the inquiry process. For example, the inquiry screen shown in FIG. 10A or FIG. 10B is displayed on the display unit 40.

At step S214, when the icon for confirming the type of paper is operated (step S214, Yes), the main controller 50 proceeds to step S217. At step S217, the main controller 50 records the type of paper with the inquiry screen in the settings table 541 as the type of paper loaded in the tray 11. Then, the main controller 50 sets the status flag to No print settings at step S218.

Also, when the user does not operate the icon (step S214, No), and operates the icon for changing the type of paper (step S215, Yes), at step S216, the main controller 50 receives input to change the paper type.

As described above, with this sixth embodiment, when print settings are not performed (second case), the type of paper set is recorded, but an inquiry is not performed. On the other hand, in cases other than print setting (first case), an inquiry is performed. Specifically, when paper is loaded after the user performs print setting, the type of paper set with the print settings is recorded as the paper loaded in the tray 11, and in other cases, only when paper loading is performed is the default value inquired.

Because of that, it is possible to lighten the burden when the user performs print settings.

### 7. Seventh Embodiment

With this sixth embodiment, when the main controller 50 is made to select the tray 11 for feeding paper, it is also possible to change the presence or absence of the inquiry according to the type of paper set with the print settings.

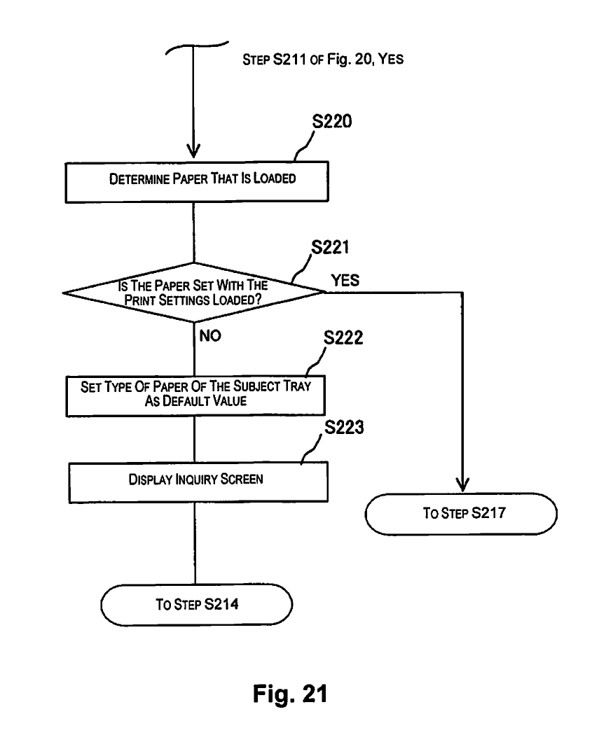

FIG. 21 is a flow chart showing the process executed by the main controller 50 with the inquiry process of the seventh embodiment. The flow chart shown in FIG. 21 is the process executed when with the flow chart shown in FIG. 20, it is detected at step S211 that it is during print setting (step S211, Yes). With the description hereafter, with the print setting, the main controller 50 is to select the tray that feeds paper, but it is also possible to have the user specify it.

The process other than that shown in FIG. 21 is the same as that of the sixth embodiment, so we will describe that using FIG. 20.

When the user loads paper in the tray 11, the main controller 50 detects that paper has been loaded, and starts the process shown in FIG. 20. Then, when the main controller 50 detects a change in the status flag (FIG. 20, step S211, Yes), it proceeds to step S220 in FIG. 21.

At step S220 in FIG. 21, the main controller 50 determines that paper has been loaded. For example, as the method for the main controller 50 to determine the type of paper that has been loaded, there are cases when it is detected that the guide has been set to a designated paper size by the detection signals from the status detection sensor 16.

Then, if the loaded paper is paper that was set with the print settings (step S221, Yes), the main controller 50 proceeds to step S217 in FIG. 20. Then, at step S217, the main controller 50 records the type of paper set with the print settings as the paper loaded in the tray 11. The main controller 50 can also perform an inquiry using the inquiry screen with the type of paper set with the print settings as the default value.

On the other hand, if the loaded paper is not the paper set with the print settings (step S221, No), the main controller 50 proceeds to step S222. At step S222, the main controller 50 sets the inquiry default value. At this time, the inquiry default value can also be the type of paper recorded in the settings table 541 for the tray 11 in which paper is loaded.

At step S223, the main controller 50 displays an inquiry screen on the display unit 40 based on the default value of the paper type that was set. Specifically, with this embodiment, when during print setting, the inquiry process is performed only when paper not set with the print setting is loaded in the tray 11.

Then, the process proceeds to step S214 in FIG. 20, and when the user operates the icon for confirming the type of paper (step S214, Yes), at step S217, the main controller 50 records the type of paper displayed in the inquiry screen 300 as the type of paper loaded in the tray 11 in the settings table 541. Then, the main controller 50 sets the status flag to No print settings at step S218. Also, when without operating the icon (step S214, No), the user operates the icon for changing the type of paper (step S215, Yes), at step S216, the main controller 50 receives input to change the paper type.

As described above, with this seventh embodiment, during print setting, when a different type of paper is set from the paper set with the print settings, since the inquiry process is performed, it is possible to suppress printing errors in accordance with mistaken loading of the paper by the user.

### 8. Eighth Embodiment

As with the fourth embodiment, there is a difference in the paper that can be loaded for each tray 11 (first paper), and when the first paper is set with the print settings, it is possible to perform the process of the sixth embodiment. Specifically, the main controller 50 does not perform an inquiry when paper is loaded in the tray 11 for which the first paper can be loaded (fed), and does perform an inquiry when paper is loaded in the tray 11 for which the first paper cannot be loaded (fed). With this eighth embodiment, when the user sets the tray for feeding paper with the print settings and when the main controller 50 automatically selects the paper feeding tray are both subjects.

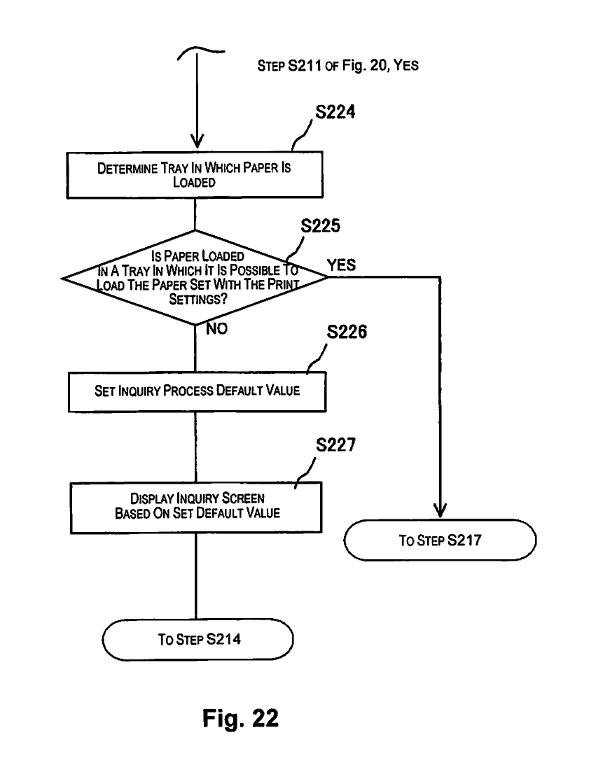

FIG. 22 is a flow chart showing the process executed by the main controller 50 with the inquiry process of the eighth embodiment. The flow chart in FIG. 22 is the process executed when in the flow chart shown in FIG. 20, and it is detected that it is during print setting at step S211 (step S211, Yes). With the description hereafter, with print setting, the tray for feeding paper is set by the main controller 50.

The process other than that shown in FIG. 22 is the same as that of the sixth embodiment, so we will describe that using FIG. 20.

When the user loads paper in the tray 11, the main controller 50 detects that paper has been loaded, and starts the process in FIG. 20. Also, when the main controller 50 detects a change in the status flag (FIG. 20, step S211, Yes), it proceeds to step S224 in FIG. 22.

At step S224 in FIG. 22, the main controller 50 determines the tray 11 in which paper has been loaded. If the tray 11 in which paper has been loaded corresponds to the type of paper set with the print settings (step S225, Yes), the main controller 50 proceeds to step S217 in FIG. 20. Specifically, the main controller 50 does not perform an inquiry.

On the other hand, if the tray 11 in which paper has been loaded does not correspond with the paper size set with print settings (step S225, No), the main controller 50 proceeds to step S226. At step S226, the main controller 50 sets the inquiry process default value. At this time, the set default value can be the type of paper set with the print settings, or can be the type of paper recorded in the settings table 541.

At step S227, the main controller 50 displays an inquiry screen on the display unit 40 based on the default value of the type of paper set. Then, it proceeds to step S214 in FIG. 20, and when the icon for confirming the type of paper is operated by the user (step S214, Yes), at step S217, the main controller 50 records the type of paper displayed on the inquiry screen 300 as the type of paper loaded in the tray 11 in the settings table 541. On the other hand, when the user does not operate that icon (step S214, No), and operates the icon for changing the type of paper (step S215, Yes), at step S216, the main controller 50 receives input to change the paper type.

As described above, with this eighth embodiment, when during print setting, when a type of paper is loaded that is different from the paper set with the print settings, when paper is loaded in the tray 11 for which the first paper cannot be loaded (fed), the inquiry process is performed, so it is possible to suppress printing errors in accordance with mistaken loading by the user.

### 9. Ninth Embodiment

As with the third embodiment noted above, by switching the interior space using the switching mechanism, when using a paper feed cassette that feeds paper from different paper placement locations inside one cassette, it is also possible to apply the sixth embodiment. Specifically, when paper is loaded in the paper placement location that was set during print setting for the paper feed cassette, an inquiry is not performed, and an inquiry is performed when paper is loaded in the paper placement location that is not set during print setting.

With the ninth embodiment, by switching the mechanism, even with a paper feed cassette for which it is possible to change the tray, it is possible to suppress printing errors in accordance with mistaken loading of the paper by the user.

### 10. Tenth Embodiment

With the sixth through ninth embodiments noted above, as with the fifth embodiment, when paper for which there is a difference with the loading direction is set with the print settings, it is possible to add a constitution for notifying the paper loading method ahead of the inquiry process.

With the kind of constitution noted above, when paper for which there is a difference in loading direction is set with the print settings, an explanation screen is displayed ahead of the inquiry, so it is possible to suppress errors when the user loads paper in the tray 11.

### 11. Eleventh Embodiment

With the third embodiment noted above, there was a sensor for detecting changes in the status of the switching mechanism 172, but it is also possible to not have this sensor, and not have the fax device 100 be able to recognize status changes of the switching mechanism 172. However, it should be possible to detect that paper has been loaded in the paper feed cassette 17. In this case, an inquiry will also be made of the status of the switching mechanism 172 (which of the upper paper placement location 171a and the lower paper placement location 171b is valid) on the inquiry screen. With this inquiry, an inquiry screen is displayed that inquires only the status of the switching mechanism 172, and when the user replies that the upper paper placement location 171a is valid, there is a switch to the inquiry screen for inquiring the paper type of the upper paper placement location 171a, and when the user replies that the lower paper placement location 171b is valid, there is a switch to the inquiry screen for inquiring the paper type of the lower paper placement location 171b. Alternatively, it is also possible to display an inquiry screen that inquires both the switching mechanism 172 status and the type of paper that was loaded using one screen. In this case, if paper was loaded in the paper feed cassette 17 in the normal state, it is also possible to dynamically switch the paper type stored correlated to the paper placement location which has changed as the valid item with the timing of the paper type displayed in accordance with there being a change before confirmation of the status of the switching mechanism 172. However, when the user changes the paper type from the default value, it is also possible to not switch the paper type even if it was changed before confirming the status of the switching mechanism 172. On the other hand, when displaying the inquiry screen that inquires both the switching mechanism 172 status and the loaded paper type with one screen, if this is an item for which the paper is loaded in the paper feed cassette 17 during print setting, even if the change is made before confirming the state of the switching mechanism 172, it is possible to not switch and leave the paper type as is as the paper type during print setting. Also, if the paper was loaded in the paper feed cassette 17 during print setting, of the upper paper placement location 171a and the lower paper placement location 171b, the paper placement location of the side set with the print setting is used as the default value of the switching mechanism 172 status for the inquiry screen. On the other hand, if it is an item for which paper is loaded in the paper feed cassette 17 in the normal state, the paper placement location of the side that was valid in advance of the upper paper placement location 171a and the lower paper placement location 171b is used as the default value of the status of the switching mechanism 172 for the inquiry screen. Then, in accordance with the user having ended input, the type of paper shown in the inquiry screen is stored in the settings table 541 as the type of paper loaded in the shown paper placement location. Also, the paper placement location shown in the inquiry screen is stored as the currently valid paper placement location.

### 12. Twelfth Embodiment

When paper is loaded in a tray other than the tray specified with print settings as the valid item, a report to that effect can be given to the user. For example, when paper is loaded in the B tray 14 during print setting for which B5 photographic paper is specified with the A tray 13, a report screen displaying a message such as “The A tray is specified, but paper has been loaded with the B tray as the valid item” is output. After that, display of the report screen is ended by the user pushing a button, and the inquiry screen is displayed. With this inquiry screen, as with the embodiments noted above, the paper type stored correlated to the B tray 14 is displayed as the default value. Alternatively, it is also possible to output a report screen on which is displayed a message such as, “The A tray is specified, but paper has been loaded with the B tray as the valid item. Feed paper from the B tray?” In this case, when the user selects No, display of the kind of report screen described above ends, and an inquiry screen is displayed with the paper type stored correlated to the B tray 14 as the default value. When the user selects Yes, display of the report screen ends, and the specification is changed to the B tray 14 instead of the A tray 13 with the print settings. After that, when the B tray 14 is specified with the print settings, the same operation is done as when the paper is loaded in the B tray 14.

### 13. Thirteenth Embodiment

As a modification of the third embodiment noted above, it is also possible to have a contrivance by which the fax device 100 switches the switching mechanism 172. In this case, when it is detected that paper is loaded in the tray 11, in accordance with this, an inquiry is made of which paper is loaded in all the paper placement locations. This inquiry can be performed through the inquiry screen that does an inquiry of the paper placement locations one at a time in sequence, or can be performed through the inquiry screen that does the inquiry for two or more paper placement locations at the same time. Then, if the paper has been loaded in a normal state, for any of the paper placement locations, the type of paper recorded up until then is used as the default value. If during the print setting for which the paper placement location doing paper feeding is specified, the value set as the print setting is used as the default value for the specified paper placement location, and the type of paper recorded up until then is used as the default value for the other paper placement locations. If during print setting with the paper placement location for feeding paper not specified, the value set as the print setting is used as the default value for paper placement locations determined to be valid according to the state of the switching mechanism 172, and the type of paper that was recorded up until then is used as the default value for the other paper placement locations. However, when the type of paper that can be loaded differs by the paper placement location, of the paper placement locations for which the paper specified with the print setting can be loaded, it is also possible to use the value set as the print setting with one paper placement location determined according to priority sequence as the default value. In particular, if there is only one paper placement location for which the paper specified with the print setting can be loaded, the value set as the print setting for that paper placement location is used as the default value.

### 14. Other Embodiments

Also, when it is possible for the fax device 100 to perform communication with a mobile terminal such as a smart phone or the like, it is also possible to use the mobile terminal as the remote control device.

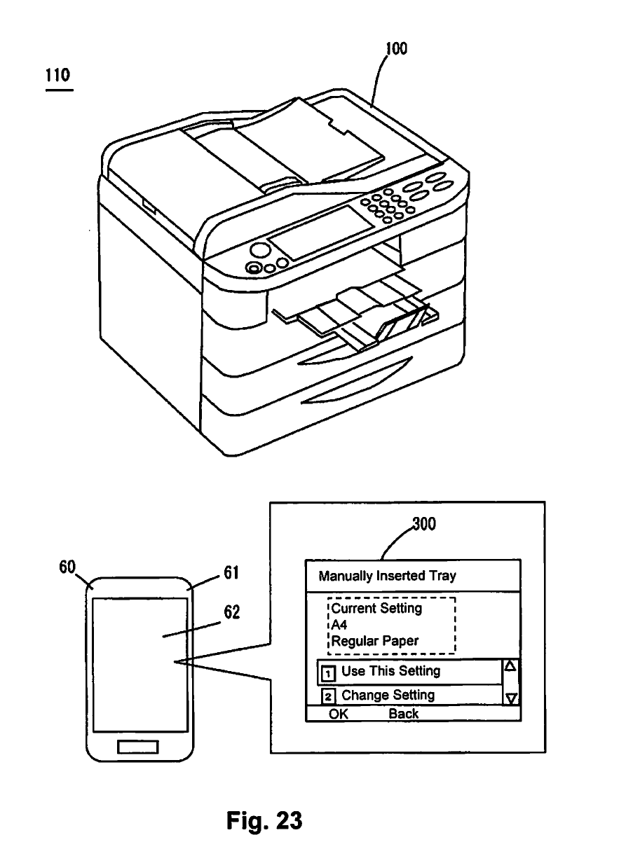

FIG. 23 is an external view of a system 110 constituted by the fax device 100 and the mobile terminal 60. For example, the fax device 100 and the mobile terminal 60 are connected via a wireless LAN or short range wireless communication.

The mobile terminal 60 is arranged with a display 62 that also functions as a touch panel exposed to the entire surface of a case 61. With this system 110, by the user operating the display 62, it is possible to have fax data that was received at the fax device 100 output (printed).

Also, the fax device 100 can be equipped with a communication interface that can communicate with the mobile terminal 60, and display the same inquiry screen as with the first through tenth embodiments noted above on the display 62 of the mobile terminal 60. Because of that, with this embodiment, the communication interface becomes the input unit that receives input from the user.

By using the constitution noted above, even when using the mobile terminal 60 as the remote control device of the fax device 100, it is possible to apply the invention.

Using an image as the inquiry is one example, and it is also possible to be an item that performs the inquiry to the user using audio. In this case, the fax device is equipped with a voice output unit such as a speaker or the like for outputting the audio, or a voice input unit such as a microphone for acquiring the user's voice, and control is done by the main controller 50.

Also, in FIG. 23, as an example, shown is the inquiry screen 300 displayed during the inquiry process executed when paper is loaded in the manually inserted tray 12. However, it will be apparent to those skilled in the art from this disclosure that display of the inquiry screen 300 is also applicable when paper is loaded in other trays, such as the A tray 13 and the B tray 14. Also, the inquiry screen is not limited to the item of the embodiments noted above, and various items can be assumed.

Also, changing the status flag is not limited to the case described above. For example, it is also possible to have the status flag be Print setting exists in accordance with the print setting having been started by the user from the home screen 200 (FIG. 6A). In this case, until the type of paper is changed by the user, the type of paper of the default with the print setting (e.g. recorded in the settings table) can be recorded in the RAM 53 as the type of paper of the print settings. Also, for example, it is possible to have the status flag be No print setting by having the print setting paper confirmed as the paper that has been loaded. Then, when paper other than the paper of the print setting is confirmed as the loaded paper, the status flag is not changed. By doing this, even when the paper initially loaded by the user is not the print setting paper, and the paper loaded after that is the print setting paper, it is possible to suppress printing errors in accordance with mistaken loading of the paper by the user. Also, for example, it is possible to have the status flag be No print setting by the type of paper for which paper is loaded in the tray specified with print setting being confirmed. Also, when paper is loaded in the tray that is not specified with print setting, the status flag is not changed. Furthermore, it is preferable that until printing is completed, the status flag be kept to the print setting, and the status flag is set to No print setting in accordance with printing being completed. The timing for setting the status flag to Print setting exists until the timing for setting the status flag to No print setting can be deemed as “during print setting.”

Furthermore, the invention that was described using the fax device 100 is one example, and it can also be understood to be a printing device.

It goes without saying that the invention is not limited to the embodiments noted above. Though this is obvious, a person skilled in the art changing as appropriate the combinations of and applying the mutually interchangeable members, constitutions and the like disclosed in the embodiments noted above, suitably interchanging members and constitutions that, though not disclosed in the embodiments noted above, are known technology and are mutually interchangeable with members, constitutions and the like disclosed in the embodiments noted above, and changing the combinations thereof and applying those, and suitably interchanging members, constitutions and the like that, though not disclosed in the embodiments noted above, are members, constitutions and the like that can be assumed to be substitutes for those disclosed in the embodiments noted above by a person skilled in the art based on known technology or the like, and changing the combinations thereof and applying them, are items that are disclosed as embodiments of the invention.

With one aspect of one embodiment, equipped are an input unit, a paper feed unit, a printing unit, a control unit, and a fax communication unit, wherein the control unit, when it detects that paper has been loaded in the paper feed unit, inquires of the user the type of paper that was loaded, records the type of paper received via the input unit as the print setting by the user, and according to the type of paper input from the user via the input unit as the print setting, has paper fed from the paper feed unit, has printing performed by the printing unit on the paper that was fed, and the inquiry, in the second case that is during the print setting, is performed with the type of paper input from the user using the print setting as the default value, and in the first case, is performed with the type of paper recorded until then as the default value.

With the embodiment constituted as noted above, when it is detected that paper is loaded in the paper feed unit, the control unit inquires of the user the type of paper that is loaded. Also, with the inquiry performed by the control unit, in the second case which is during print setting, this is performed with the type of paper input from the user as the print setting as the default value, and in the first case which is in a normal state, it is performed with the type of paper recorded up until then as the default value. Specifically, with the inquiry, if the paper set in advance with the print setting is the default value, it is possible to confirm the setting as is. On the other hand, when print setting has not been performed, the type of paper recorded up until then is used as the default value.

Because of that, only when performing print settings, the set paper type is reflected as the default value, so it is possible to lighten the burden on the user when loading the paper.

Here, in addition to the part that receives operation from the user through the operating unit constituted as a part of the fax device, the input unit includes a part for receiving the sent input when the user operates an external device and sends input to the device.

Also, the inquiry can be anything as long as it is an item that inquires of the user the type of paper, and in addition to display on a screen, is a concept that also includes audio.

Also, print setting is a general name for setting when performing printing on paper, and includes setting when receiving a fax or copying.

“Detected that paper is loaded” is not limited to the detection of paper directly by a sensor, but also includes indirect detection using a sensor or the like such as with detecting that the tray in which paper is to be loaded has been loaded. In a case with this kind of indirect detection, even when paper is not actually loaded in the tray, it is possible to be detected that paper has been loaded using the fact that the tray has been loaded.

With one aspect of the embodiment, the paper feed unit has a plurality of paper placement locations, when the paper is loaded in the paper placement location that is the subject of user input via the input unit as the print setting in the second case, the inquiry has the type of paper input from the user as the default value, and when the paper is loaded in the paper placement location that is not the subject of user input via the input unit as the print setting in the second case, the inquiry has the type of paper recorded up to then as the default value.

With the embodiment constituted as noted above, the default value of the inquiry changes according to the paper placement location in which the user loads the paper, so even when the paper placement location is set using the print settings, it is possible to apply the present embodiment.

Here, the paper placement location is constituted as a part of the paper feed unit, and means the location in which paper fed by the paper feed unit is loaded, and includes paper trays and paper cassettes.

With one aspect of the present embodiment, the paper placement location is a paper feed cassette that is equipped with a switching mechanism for mechanically selecting the paper placement location that will be the paper feed source by operation by the user.

With the embodiment constituted as noted above, even when different paper placement locations are equipped within one paper feed cassette, it is possible to apply the present embodiment.

With one aspect of the present embodiment, there are further equipped a first paper placement location in which a first paper can be loaded, and a second paper placement location in which the first paper cannot be loaded, and in the second case for which the first paper was input with the print settings, when the paper is loaded in the first paper placement location, the inquiry is performed with the first paper as the default value, or when paper is loaded in the second paper placement location, is performed with the type of paper recorded until then as the default value.

With the embodiment constituted as noted above, when there are limits on the paper that can be loaded for each paper placement location, the inquiry default value is changed, so it is possible to reduce errors in loading of the paper by the user.

With one aspect of the present embodiment, when the user inputs a paper for which there is an orientation difference as the print setting, before the inquiry, the control unit guides the user in the loading method of the paper that has an orientation difference, or when the user inputs a paper for which there is not orientation difference as the print setting, the control unit does not guide the user in the loading method of the paper.

With the embodiment constituted as noted above, the paper loading method is guided before the inquiry, so it is possible to reduce paper loading errors by the user.

With one aspect of the present embodiment, a display unit is equipped, and the inquiry is performed by the display unit displaying an image.

With the embodiment constituted as noted above, it is possible to visually notify the user of the default value inquiry.

Also, the present embodiment can be understood as a printing device equipped with an input unit, a paper feed unit, a printing unit, and a control unit, wherein the control unit records the type of paper received via the input unit as the print setting by the user, and the control unit feeds paper from the paper feed unit according to the paper type input from the user via the input unit as the print setting, and has the printing unit perform printing on the fed paper, and

the control unit, in a first case when paper is detected to have been loaded in the paper feed unit in a normal state, inquires of the user the type of paper loaded, and in a second case when it is detected that it is during a print setting using a type of paper different from the stored type of paper, does not perform the same inquiry as with the first case.

It can also be understood as a printing device for which the paper feed unit has a plurality of paper placement locations, and the control unit is able to detect that paper has been loaded in the paper feed unit, but it is not possible to detect which of the paper placement locations the paper has been loaded in, and the control unit, in the second case, using the paper type input from the user and the used paper placement location as the print setting as the default value, performs inquiry to the user of the loaded paper type and the paper placement location.

Furthermore, it is possible to understand it as a printing device equipped with an input unit, a paper feed unit, a printing unit, and a control unit, wherein the paper feed unit has a plurality of paper placement locations, and the control unit is able to detect the fact that paper has been loaded in the paper feed unit, but is not able to detect which of the paper placement locations the paper has been loaded in, and the control unit performs an inquiry to the user of the type of paper that was loaded and the paper placement location, according to detection that paper was loaded in the paper feed unit, and the control unit has paper fed from the paper placement location included in a reply according to a reply to the inquiry input from the user via the input unit, and has the printing unit perform printing on the fed paper.

It can further be understood to be a printing device for which with the plurality of paper placement locations, paper feeding is possible with only one of these as being valid at the same time, and the control unit performs an inquiry with the paper placement location stored as the valid item up until then as the default value, and records the paper placement location included in the reply as the valid paper placement location.

The present embodiment can also be understood not only as a fax device, but can also be understood as a printing device.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A printing device, comprising:
an input unit;
a paper feed unit;
a printing unit; and
a control unit,
the control unit being configured to record a type of paper received via the input unit as a print setting by a user,
the control unit being further configured to, according to a type of paper input from the user via the input unit as the print setting, cause the paper feed unit to feed paper, and cause the printing unit to perform printing on the paper that has been fed,
the control unit being further configured to, in a first case where the paper is detected to be loaded in the paper feed unit in a normal state, inquire of the user a type of paper loaded, and being further configured not to perform the same inquiry as with the first case in a second case where the paper is detected to be loaded in the paper feed unit during the print setting using a type of paper different from the type of paper being recorded.

2. The printing device according to claim 1, wherein
the control unit is further configured to, in the second case, perform an inquiry with the type of paper, which is input from the user as the print setting, as a default value, and in the first case, perform an inquiry with the type of paper, which has been recorded, as the default value.

3. The printing device according to claim 2, wherein
the paper feed unit has a plurality of paper placement locations, the paper placement locations include a first and second paper placement locations,
when the paper is loaded in the first paper placement location that is a subject of input by the user via the input unit as the print setting in the second case, the inquiry has, as the default value, the type of paper input from the user, and
when the paper is loaded in the second paper placement location that is not the subject of input by the user via the input unit as the print setting in the second case, the inquiry has, as the default value, the type of paper that has been recorded.

4. The printing device according to claim 3, wherein
the paper placement locations include a paper feed cassette equipped with a switching mechanism configured to mechanically define one of the paper placement locations, which is selected as a paper feed source by operation of the user.

5. The printing device according to claim 2, wherein
the paper feed unit has a plurality of paper placement locations,
the control unit is further configured to detect whether or not the paper is loaded in the paper feed unit, and is further configured not to detect which of the paper placement locations the paper is loaded in, and
the control unit is further configured to, in the second case, perform the inquiry to the user of the type of paper loaded and a paper placement location, with, as the default value, the type of paper and the paper placement location being used, which are input from the user as the print setting.

6. The printing device according to claim 2, wherein
the paper feed unit has
a first paper placement location configured to load a first paper thereon, and
a second paper placement location configured not to load the first paper thereon, and
in the second case for which the first paper is input with the print setting, the control unit is further configured to perform the inquiry with the first paper as the default value when the paper is loaded in the first paper placement location, or the control unit is further configured to perform the inquiry with, as the default value, the type of paper that has been recorded when the paper is loaded in the second paper placement location.

7. The printing device according to claim 1, wherein
the control unit is further configured not to perform an inquiry of the type of paper in the second case when the paper is loaded in the paper feed unit, and is further configured to regard the type of paper input from the user as the print setting as being the paper which is loaded.

8. The printing device according to claim 7, wherein
the paper feed unit has a plurality of paper placement locations,
the control unit is further configured not to perform the inquiry for paper which is a subject of input by the user via the input unit as the print setting in the second case, and
the control unit is further configured to perform the inquiry for paper which is not the subject of input by the user via the input unit as the print setting in the second case.

9. The printing device according to claim 8, wherein
the paper placement locations include a paper feed cassette equipped with a switching mechanism configured to mechanically define one of the paper placement locations, which is selected as a paper feed source by operation of the user.

10. The printing device according to claim 7, wherein
the paper feed unit has
a first paper placement location configured to load a first paper thereon, and
a second paper placement location configured not to the first paper thereon, and
in the second case when the first paper is input with the print setting, the control unit is further configured not to perform the inquiry when the paper is loaded in the first paper placement location, and the control unit is further configured to perform the inquiry when the paper is loaded in the second paper placement location.

11. The printing device according to claim 1, wherein
in a case where paper with an orientation difference that the user has tried to load is detected when the paper with the orientation difference is input by the user as the print setting, the control unit is further configured to guide the user in a loading method of the paper with the orientation difference.

12. The printing device according to claim 1, further comprising
a display unit,
the control unit being further configured to perform the inquiry by causing he display unit to display an image.

13. The printing device according to claim 1, further comprising
a fax communication unit,
the control unit being further configured to cause the printing unit to perform the printing based on fax data received through the fax communication unit.

14. A printing device, comprising:
an input unit;
a paper feed unit, the paper feed unit having a plurality of paper placement locations;
a printing unit; and
a control unit;
the control unit being configured to detect that paper is loaded in the paper feed unit, and configured not to detect which of the paper placement locations the paper is loaded in,
the control unit being further configured to perform an inquiry to a user of a type of paper loaded and a paper placement location according to detection that paper is loaded in the paper feed unit, and
the control unit being further configured to cause, according to a response to the inquiry input from the user via the input unit, the paper placement location included in the response to feed the paper, and cause the printing unit to perform printing on the paper that has been fed.

15. The printing device according to claim 1, wherein
one of the plurality of paper placement locations is configured to feed the paper as a valid paper placement location at a time,
the control unit is further configured to perform the inquiry with, as the default value, the paper placement location, which has been recorded as the valid paper placement location, and
the control unit is further configured to record the paper placement location included in the response as the valid paper placement location.
